(19) United States
(12) Patent Application Publication
(10) Pub. No.: US 2009/0212475 A1
(43) Pub. Date: Aug. 27, 2009

(54) Fastening Means Preventing The Transmission of Shocks and Vibrations

(76) Inventor: Hermann Tropf, St. Leon-Rot (DE)

Correspondence Address: BOND, SCHOENECK & KING, PLLC, 10 BROWN ROAD, SUITE 201, ITHACA, NY, 14850-1248, US

(21) Appl. No.: 11/994,476

(22) PCT Filed: Jun. 29, 2006
(86) PCT No.: PCT/EP06/06329

§ 371 Date: Oct. 15, 2008

(30) Foreign Application Priority Data
Jul. 3, 2005 (DE) 10 2005 031 303.5
Apr. 17, 2006 (DE) 10 2006 018 071.2

(51) Int. Cl. F16F 15/02

(52) U.S. Cl. 267/75

(57) ABSTRACT

In an apparatus for connecting a structural member (12) with a structural unit (2), an oscillation device (4) serves for absorbing impulses or vibrations. It is excited by impulses or vibrations around oscillations about a first point (7) which lies on or near a natural oscillation nodal point. The structural member (12) is rotatably supported in the first point relative to the oscillator.

A damping device (30) has an effective component which lies in basic oscillation in the direction of motion of the first point, and serves for damping a basic oscillation. An optional additional classic dynamic vibration absorber is tuned to the basic oscillation of the oscillation device.

The fields of application are extremely manifold and range from oscillation-absorbing and shock-absorbing supports (for hard disks, cameras, illuminants, mirrors, microphones, motors etc.) over grab handles of hand-operated vibrating devices to translatory shock absorption in vehicles on wheel suspension or seat holders, as well as to the rotatory shock absorption in the power train.

The present invention relates to a means for attachment or power connection with which, to a large extent, the transmission of shocks and vibrations can be prevented.

### STATE OF THE ART

A classic constructional element in structural engineering and mechanical engineering is the so-called classic dynamic vibration absorber (Tilger). In structural engineering, swinging masses are used for stabilization, e.g. pendulums for the earthquake protection of high towers. In mechanical engineering, resiliently suspended, specifically dimensioned masses are mounted in a particular place for compensation purposes; this, however, only applies to a particular frequency which for particular applications must be fine tuned. Thus, a damping of frequencies to which the classic dynamic vibration absorber is not attuned, does not take place.

GB 1498222 relates to a device for interconnecting the drive device or lift unit of a helicopter and the fuselage of a helicopter. This device comprises a beam which is brought into vibration by the vertical forces produced by the rotor blades. The fuselage of the helicopter is connected to the beam at the outer ends thereof. In the mounted state, oscillation nodal points are necessarily found there so that motion from the rotor is not transmitted to the fuselage. In the unmounted state, it is not possible that oscillation nodal points are found there.

GB-A-2080921 relates to a vibration damping handle device for an electromotive tool which transmits vibrations. The handle device comprises a vibration receiving member which is substantially rigidly connected, via a connecting element, with the housing of the tool, and which is capable of receiving an initial vibration from the tool. A pair of first vibration-damping bodies is attached to the respective opposite ends of said vibration receiving member. A further pair of second vibration-damping bodies is disposed outside each respective one of said first vibration-damping bodies and connected via an elastic spring, here called a damper member, to the respective first vibration-damping bodies. A pair of third vibration-damping bodies is provided on the inside of the respective first vibration-damping bodies. A hand-grip member is attached to the third vibration-damping bodies. By corresponding adjustment of the masses of each vibration-damping body and of the so-called damper member realized as spring, an oscillation nodal point is to be formed in the middle of the vibration-receiving member, i.e. between the pair of third vibration-damping bodies. By said arrangement, the handle device is claimed to be isolated physically and mechanically from other points of the vibration systems. The springs and vibrating masses positioned outside the handle bear a risk of injury.

### Problem:

It is the object of the present invention to provide a means for attachment or power connection with which, to a large degree, the transmission of vibration can be prevented independently of the exciting frequency (in as large a frequency range as possible), in particular in case of wide-band excitation, such as from short shocks.

### Solution:

This object is achieved with an apparatus according to the independent claims.

The apparatus for connecting a structural member with a structural unit comprises: a) at least one oscillation device coupled to the structural unit and the structural member, where the oscillation device exhibits a particular natural oscillation characteristic, in which at least one oscillation nodal point is formed upon excitation by impact or vibration, b) wherein the structural member at the oscillation device is arranged on at least one connecting point which is situated on or near the oscillation nodal point(s), and c) at least one damping device for damping a basic oscillation of the oscillation device relative to the structural unit.

The structural member is rotatably attached to the oscillation or swinging device.

In accordance with the present invention, the attachment is made at or near the free oscillation nodal point(s). Free oscillation nodal points are always found inside a part.

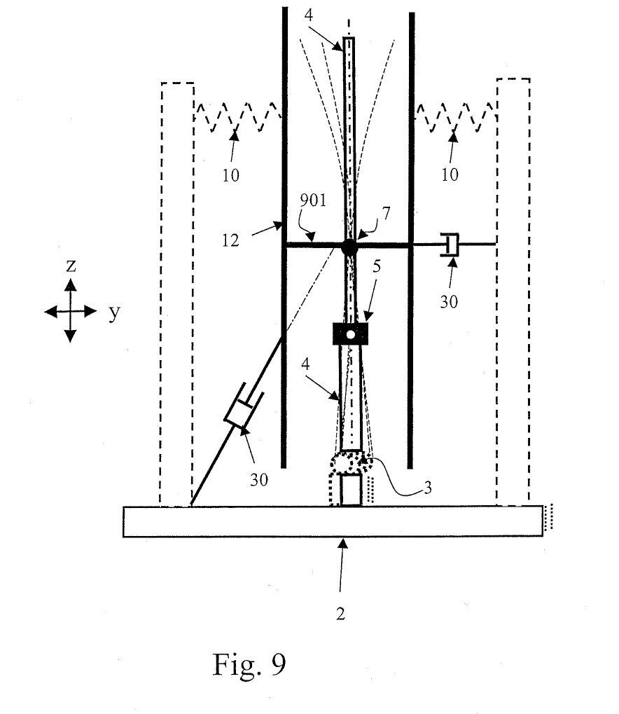

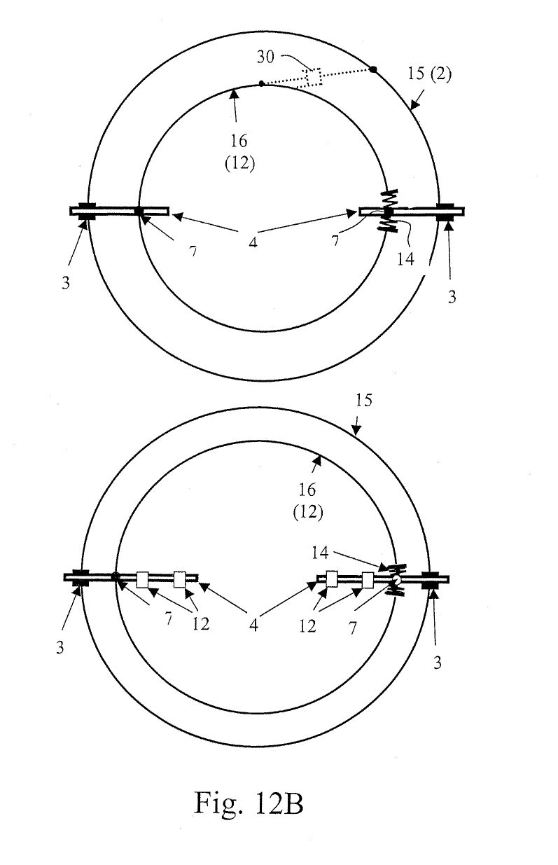

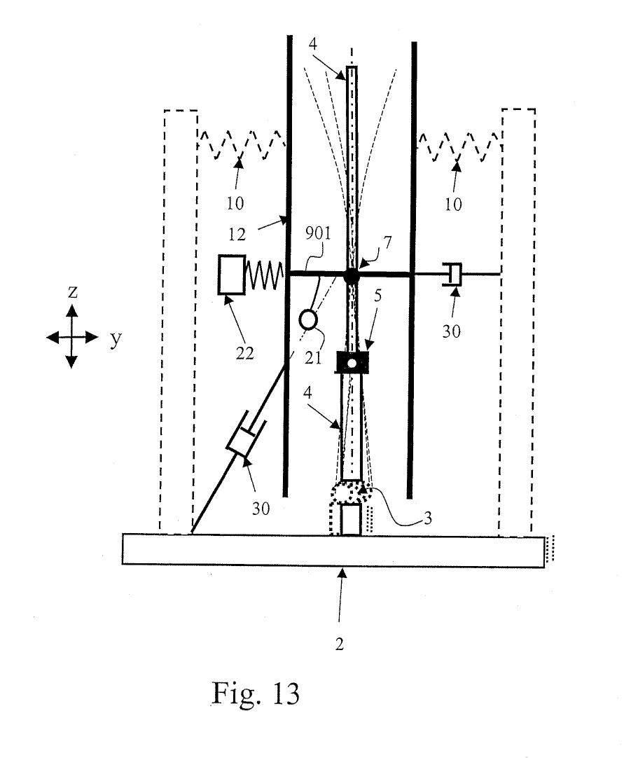

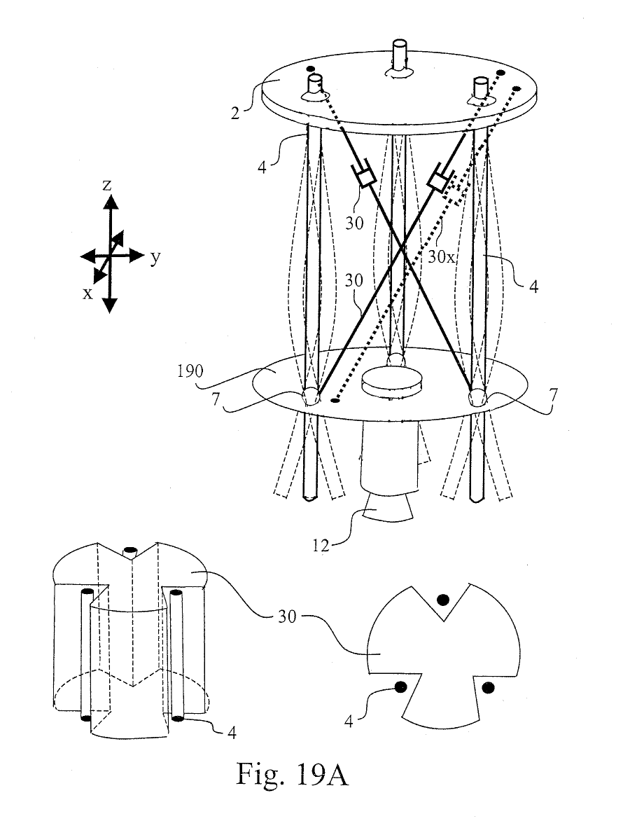

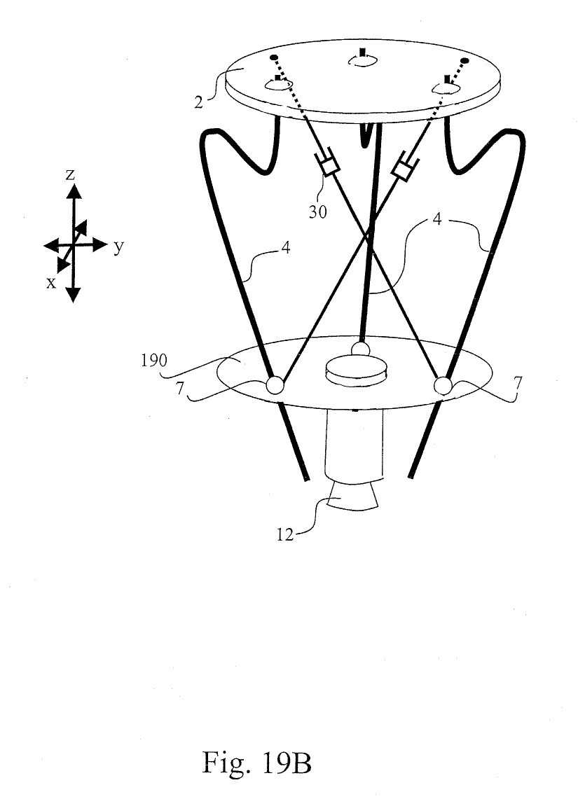

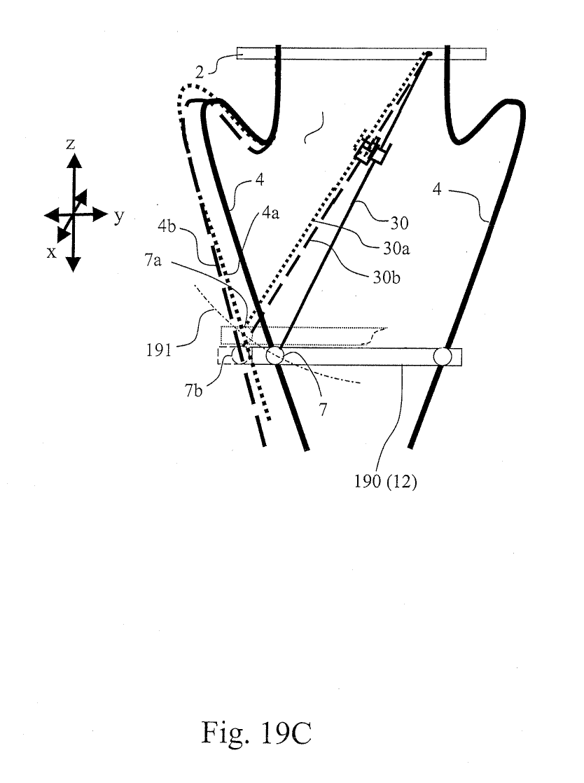

The damping device is attached to the oscillation device on or near at least one of the oscillation nodal points, either directly or by means of a first structural element. Examples of first structural elements are found in the working examples (e.g. plate 190 in FIG. 19A, structural element 901 in FIG. 9 and FIG. 13; description see below).

The damping device is connected with the structural unit in such a manner that the damping device has an effective component which in case of basic oscillation lies in the direction of motion of the connecting point.

Energy produced by impulse or vibration is at least partly converted in oscillation energy around oscillation nodal points.

The oscillation or swinging device will hereinafter also be briefly referred to as oscillator.

When the oscillation device is connected with the structural unit, but otherwise free, in case of impulses or vibrations there are formed at the oscillation device oscillations about at least one oscillation nodal point, in this case also called free oscillation nodal point.

A connecting point where the structural member is rotatably attached to the oscillation device will hereinafter also be referred to as “first point”. The first point is found at a free oscillation nodal point or at least near one. If it is only found near the free oscillation nodal point, the position of the oscillation nodal point will be shifted from the free oscillation nodal point toward the first point, in view of the position of the connecting point and the mass situated there (“shifting of the oscillation nodal point”). To simplify the illustration, in the following examples it is assumed that the first point coincides with the free oscillation nodal point.

In contrast to the above mentioned GB 1498222, in the present invention, the means for attachment is not situated at an oscillation nodal point which necessarily follows from the attachment, but at a free oscillation nodal point or at least near one.

The structural member will hereinafter also be referred to as mass.

In case of the above mentioned oscillations, the oscillation nodal points are at rest. However, the above mentioned oscillations having at least one oscillation nodal point are possibly superimposed by a (lower-frequency) basic oscillation where the oscillation nodal points move.

For shock absorption, oscillations around the oscillation nodal points are desirable, while basic oscillation is undesirable. The present invention is based on the basic concept to at least partially convert shock energy introduced into a system by impulse or vibration in oscillation energy. By connecting a structural member at the oscillation device in the area of the oscillation nodal point, the transmission of vibrations is avoided.

The damping device suppresses or at least reduces a possibly occurring undesirable basic oscillation. It is dimensioned such that, on the one hand, the basic oscillation subsides as soon as possible and that, on the other hand, there is no substantial shock transmission from the structural unit to the structural member via the damping device. This dimensioning has surprisingly proved to be uncritical in a large number of cases.

No suppression of the basic oscillation via a damping device can be found in the above mentioned references GB 2080921 A and GB 1498222.

Any swinging structure which is capable of freely oscillating around a point is suitable as oscillator. The oscillator may consist of a single element or be composed of a plurality of elements. The oscillator consists of at least one resilient element and may be complemented by auxiliary masses and damping elements (preferably mounted on natural antinodes, examples see below).

The frequency of an optional additionally attached classic dynamic vibration absorber is tuned to the basic oscillation of the oscillator.

If both a classic dynamic vibration absorber and a damping member are used, the damping characteristics of the classic dynamic vibration absorber (i.e. a damper (Tilgerdämpfer) arranged in parallel to the damper spring (Tilgerfeder), as known) and of the damping member are preferably attuned to each other in such a way that the basic oscillation disappears at the latest after a few oscillations.

### Field of Application:

The invention has the advantage that the structural unit and the structural member in an existing system or an existing construction need not be changed. Instead, the designing and dimensioning of the oscillation device comprising the damping device may be performed independently of structural unit and structural member, it being possible to take into account the existing operational conditions and/or forces and/or masses of the structural unit and of the structural member. This applies, in case of possibly existing natural frequencies of the structural unit around oscillation nodal points, independently of their position and accessibility. In addition, the invention may be applied to various systems according to a modular design principle.

The solution according to the present invention can be utilized for a large number of applications: wherever there is an object (mass) to be decoupled from the shocks or vibrations produced by a device with which the object is in mechanical connection. One motivation for using the system may also be to protect a drive unit (motor, axle, gear transmission) provided on the structural unit: by a resilient connection between structural unit and structural member, the drive side is protected without that swinging movements occur, such as in simple spring-mass systems.

The invention is applicable to a shock- and vibration-damping attachment of cameras on a robot handling: due to the automatic control oscillations of the robot there result vibrations interfering with image capturing, in particular in case of long robot arms, as well as in case of abrupt changes of the velocity vector; in case of single image capturing, the latter may require considerable calm down periods, which extend the cycle length. Such cycle length extensions may be of crucial importance for the profitability of the entire facility.

Analogously, the above described problem occurs in strongly accelerated parts in devices, e.g. in the guidance of printheads in printers or in the wire feeding of bond machines, but also in inscription means.

The invention may inter alia be used for the impulse suppressing and vibration suppressing support of cameras mounted on vibrating poles or on support frames, in the vicinity of which, for example, a punch is arranged, of mirrors (rearview mirrors of vehicles, mirrors in test equipment, such as mirror galvanometers), of active elements, such as laser pointers, as used, for example, in structural engineering for surveying, of structured light projectors (structured light for image processing), of vehicle headlights and of projectors (such as beamers which are to be attached to vibrating parts of a building).

The present invention may also be used for attaching hard disks or other shock-sensitive devices or for the shock and vibration damping installation of laboratory benches and apparatuses.

The invention may also be used for the suppression of recoil and/or vibration in hand-operated devices such as jackhammers, roto hammers, hedge shears, screw drivers and the like, but also for simple hammers.

The invention may also be used for impulse and vibration suppression in vehicles (wheel suspension, driver's seat, bicycle saddle, etc.).

The invention may also be used as vibration-damping motor holder in vehicles or device housings.

The invention may further be used for the impulse and vibration suppressing mounting of measuring sensors, such as microphones, and is particularly interesting for capturing the structure-borne sound of the part to which the receiver/sensor as such is attached.

The invention may also be used with a chassis, for the suppression of a reciprocal action of the attached accelerated parts (by linear axle, pneumatic cylinder, robot, band stopper member, etc.) on the chassis.

The invention may also be used for attaching loudspeakers or loudspeaker systems in order to suppress the—usually not foreseeable—resonances of the parts to which the loudspeaker is attached or with which it is in direct or indirect touch. In an analogous manner, the invention may also be used for silencing, e.g. in motor attachment, in order to suppress undesirable resonances of a vehicle (i.e. resonances having more than one frequency).

The invention may also be used for the absorption of rotary shocks, such as in the power transmission of automobiles, in machine tools or in (hand-operated) screwdriver machines.

The invention may also be utilized for shock absorption in buildings, in particular with the aim of earthquake protection.

In the following, the invention will be described in more detail by non-limiting working examples with reference to the drawings, in which:

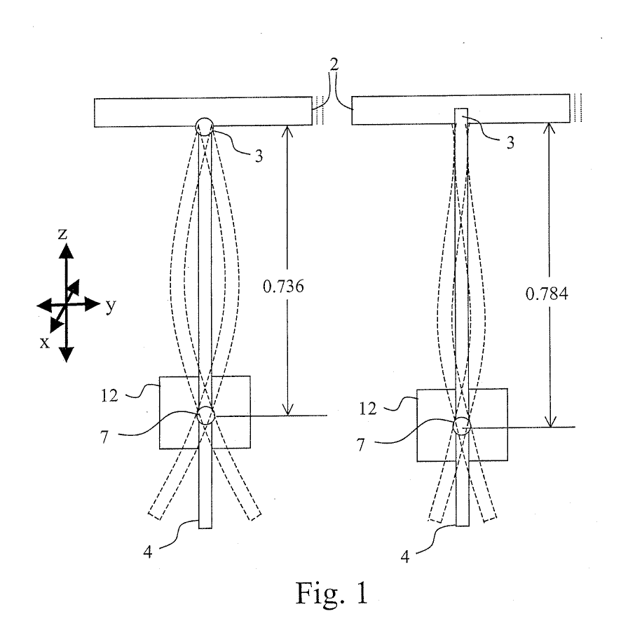

FIG. 1 is a schematic view of a rod-shaped transversal oscillator being restrained on one side via a joint (left illustration) and fixedly restrained on one side (right illustration), and forming a stationary oscillation nodal point (“first harmonic”),

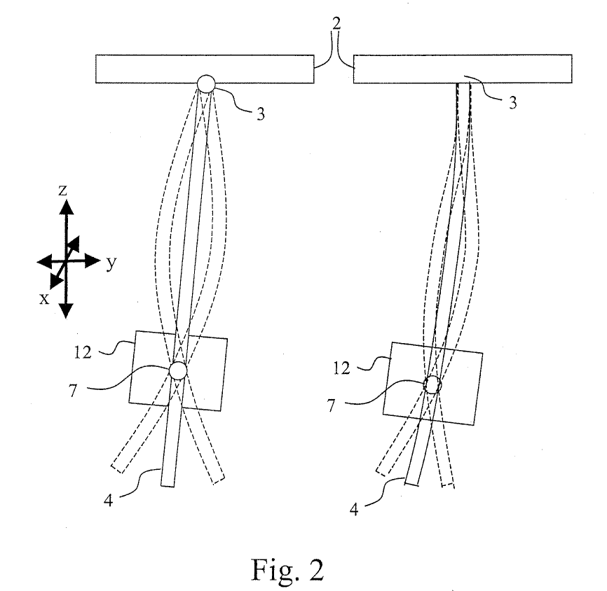

FIG. 2 shows a rod-shaped transversal oscillator as shown in FIG. 1 with an additionally existing basic oscillation,

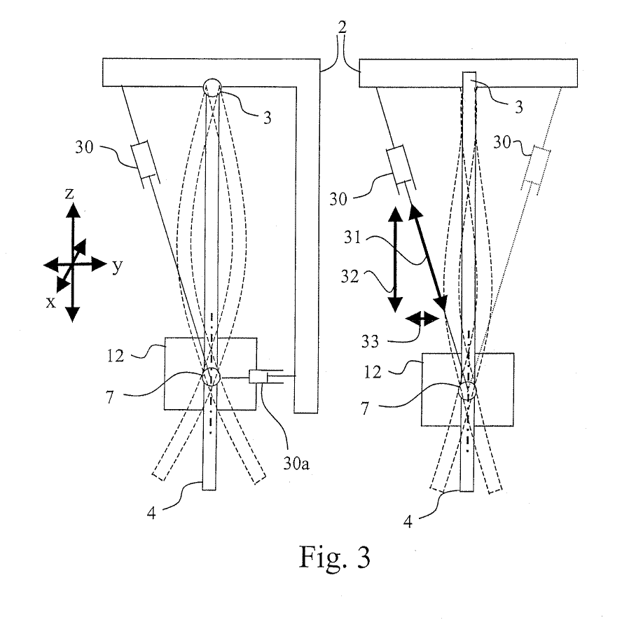

FIG. 3 is a schematic view of a first embodiment of the present invention of a rod-shaped transversal oscillator with damping device (the left illustration showing a diagonal and a horizontal damper in the y-direction, the right illustration showing one, optionally two diagonal dampers),

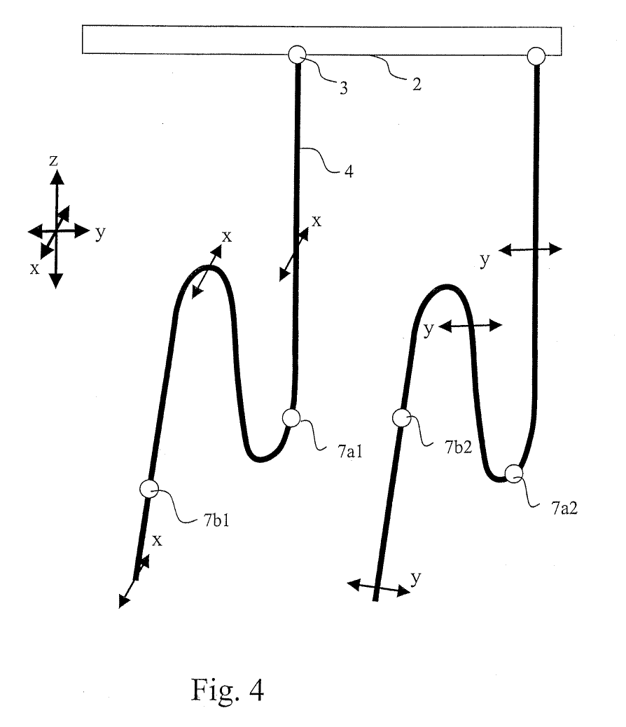

FIG. 4 is a schematic view of a second embodiment of the invention with twice bent rod (the left illustration shows oscillations in the x-direction, the right illustration shows oscillations in the y-direction), with partly approximately coinciding oscillation nodal points,

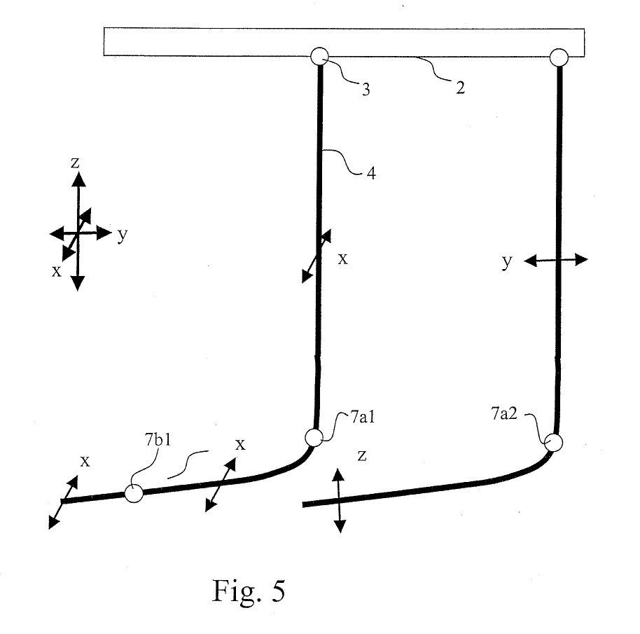

FIG. 5 is a schematic view of a third embodiment of the invention with once bent rod (the left illustration shows oscillations in the x-direction, the right illustration shows oscillations in the y- and z-directions), with partly approximately coinciding oscillation nodal points,

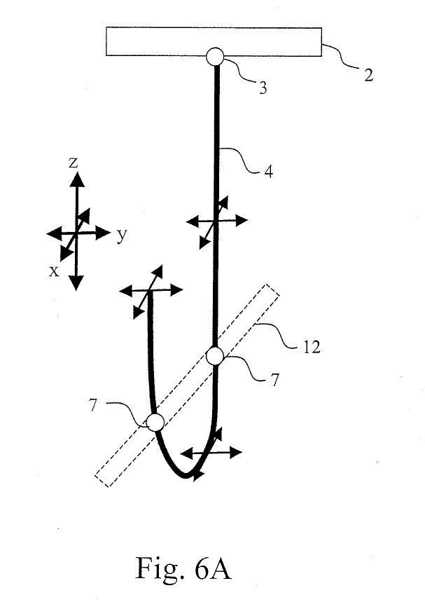

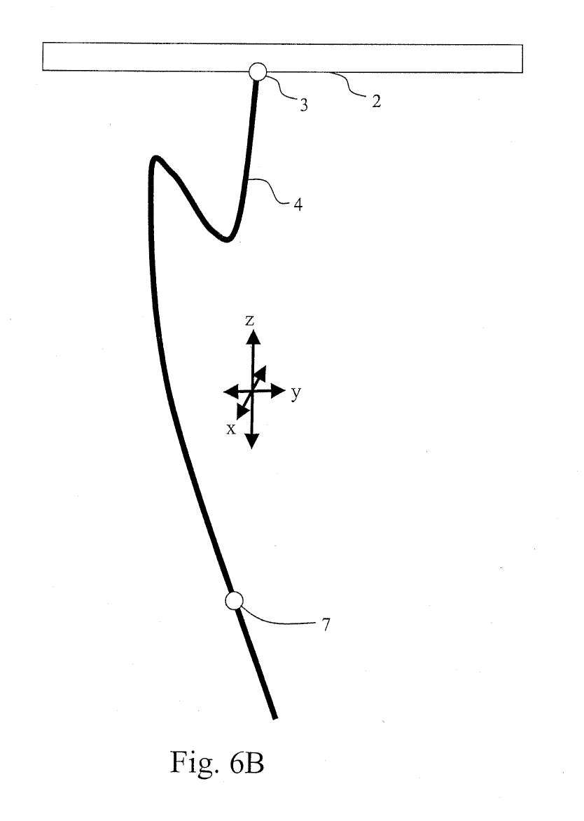

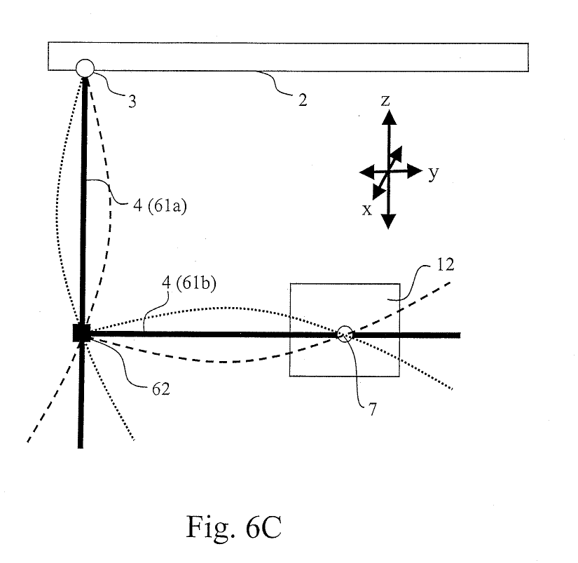

FIG. 6A is a schematic view of a fourth embodiment of the invention with a bent rod (with oscillations in the x- and y-directions), with two first points on different oscillation nodal points of the same oscillator,

FIG. 6B is a schematic view of a fifth embodiment of the invention of a bent rod having three degrees of freedom (with oscillations in the x-, y- and z-directions),

FIG. 6C is a schematic view of an embodiment of the invention with two series-connected oscillators for three degrees of freedom,

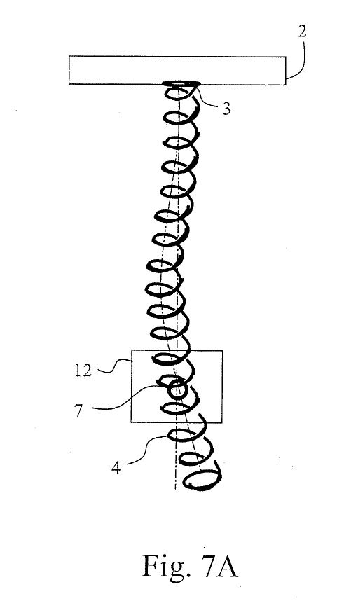

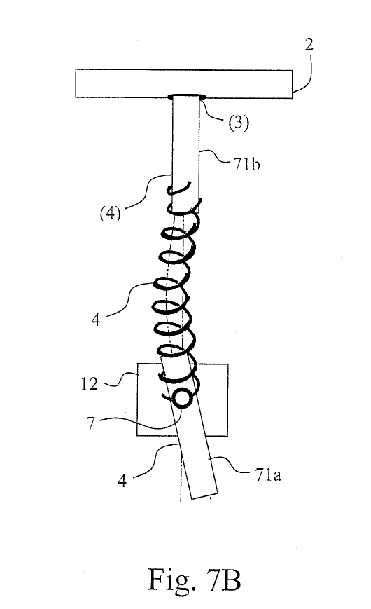

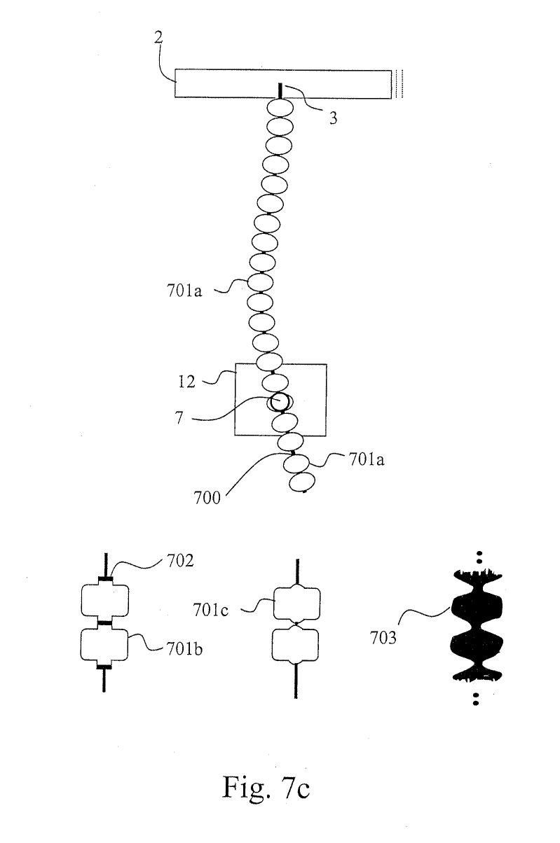

FIG. 7A is a schematic view of a sixth embodiment of the invention with coil spring, with transversal oscillations,

FIG. 7B is a schematic view of a seventh embodiment of the invention with a combination of coil spring and rigid rod,

FIG. 7C is a schematic view of an eighth embodiment of the invention with core material and auxiliary bodies, with enlarged sectional view of three alternatives,

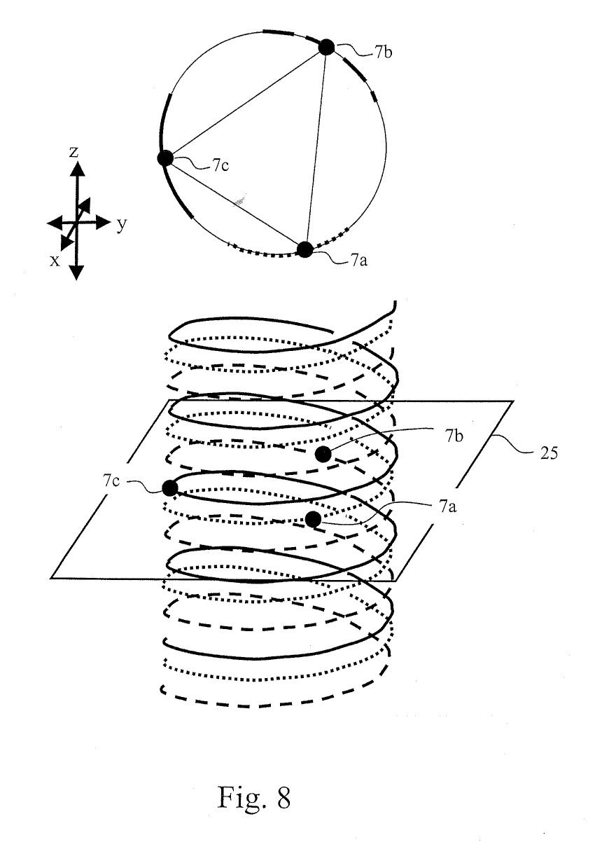

FIG. 8 is a schematic view of a ninth embodiment of the invention with three intertwined coil springs, and schematic diagram in a topview of three oscillation nodal points (illustration at the top),

FIG. 9 is a schematic view of a tenth embodiment of the invention with a standing swinging rod,

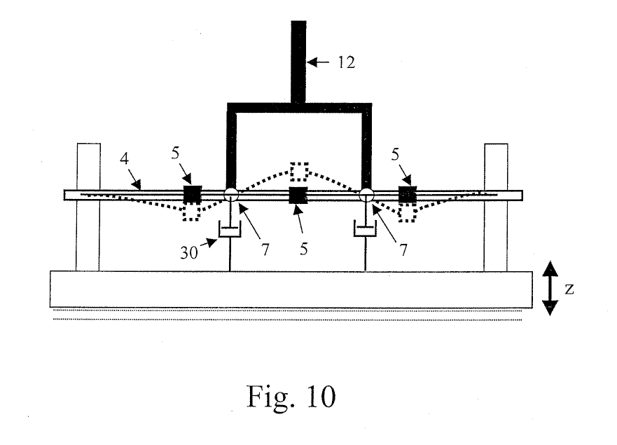

FIG. 10 is a schematic view of an eleventh embodiment of the invention with an oscillator restrained on both sides,

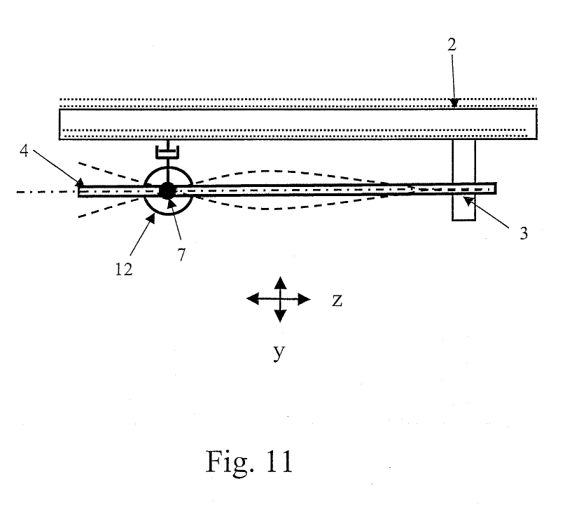

FIG. 11 is a schematic view of a twelfth embodiment of the invention with a firmly restrained oscillator,

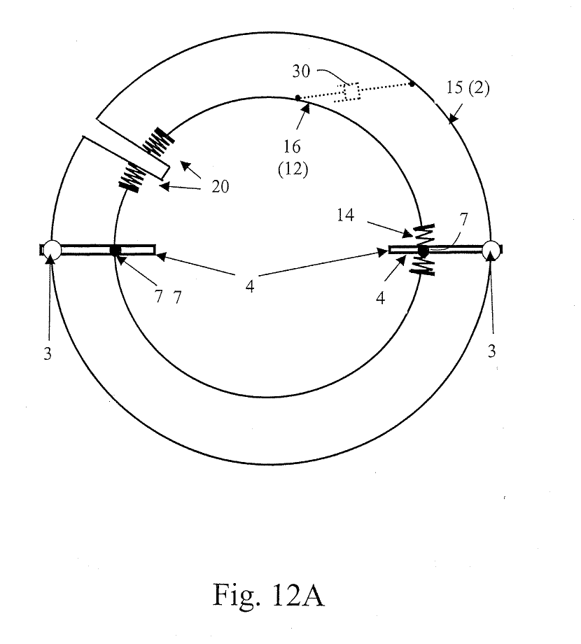

FIG. 12A is a schematic view of a thirteenth embodiment of the invention with transversally swinging elements, with the swinging rod being restrained via a joint,

FIG. 12B is a schematic view of a fourteenth embodiment of the invention with transversally swinging elements with the swinging rod being firmly restrained (top illustration with damper, bottom illustration for a higher mode of oscillation),

FIG. 13 is a schematic view of a fifteenth embodiment of the invention, similar to that of the tenth embodiment, with classic dynamic vibration absorber,

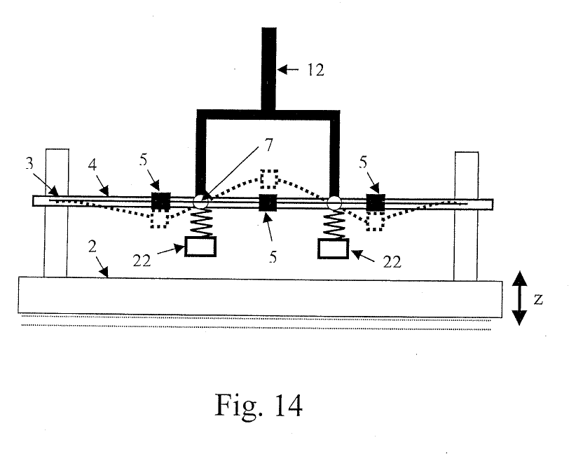

FIG. 14 is a schematic view of a sixteenth embodiment of the invention, similar to that of the eleventh embodiment, with a classic dynamic vibration absorber,

FIG. 15 is a schematic view of a seventeenth embodiment of the invention, similar to that of the fourteenth embodiment, with swinging rods having different resonance frequencies,

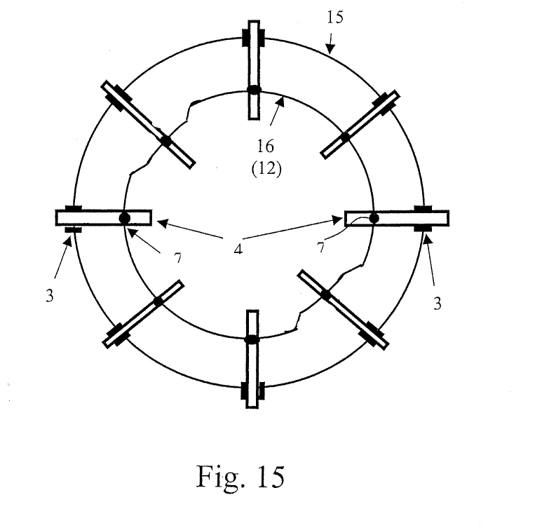

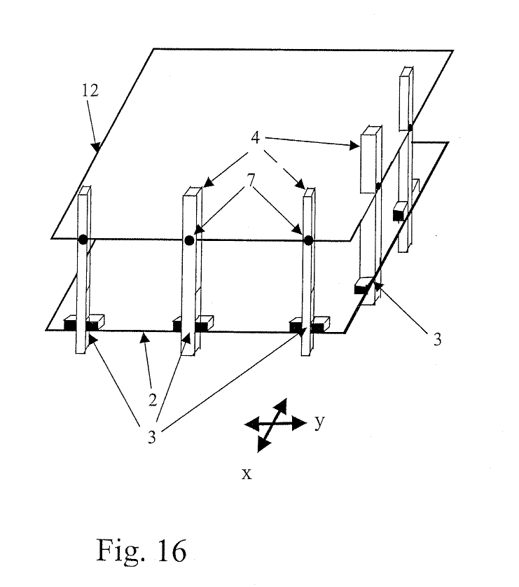

FIG. 16 is a schematic view of an eighteenth embodiment of the invention with swinging rods of different sizes connected in parallel,

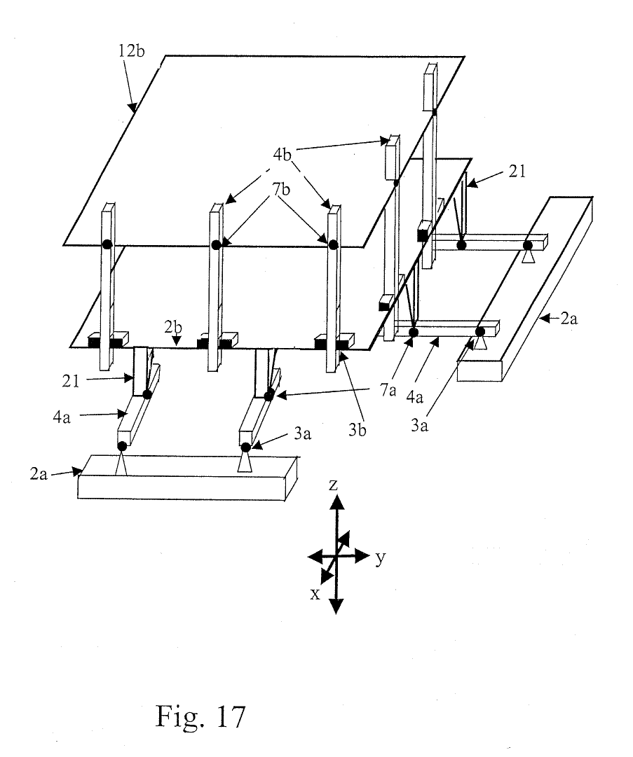

FIG. 17 is a schematic view of a nineteenth embodiment of the invention with two arrangements according to the eighteenth embodiment connected in series,

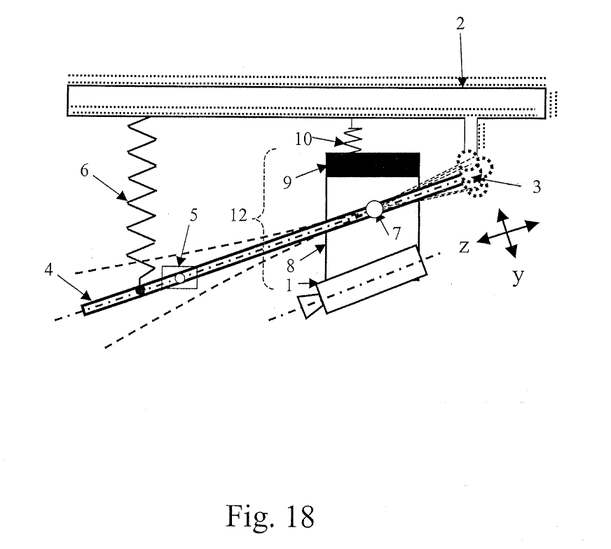

FIG. 18 is a schematic view of a twentieth embodiment of the invention of an oscillator consisting of a plurality of elements capable of oscillation,

FIG. 19A is a schematic view of a twentyfirst embodiment of the invention with rods arranged in parallel with a detail view of an alternative embodiment of a damping device (perspective view bottom left, top view bottom right),

FIG. 19B is a schematic view of a twenty-second embodiment of the invention, similar to that of the twentyfirst embodiment, however for three degrees of freedom, with swinging rods according to the fifth embodiment,

FIG. 19C is a schematic view corresponding to the twenty-second embodiment, for illustration of the dimensioning of the damping device,

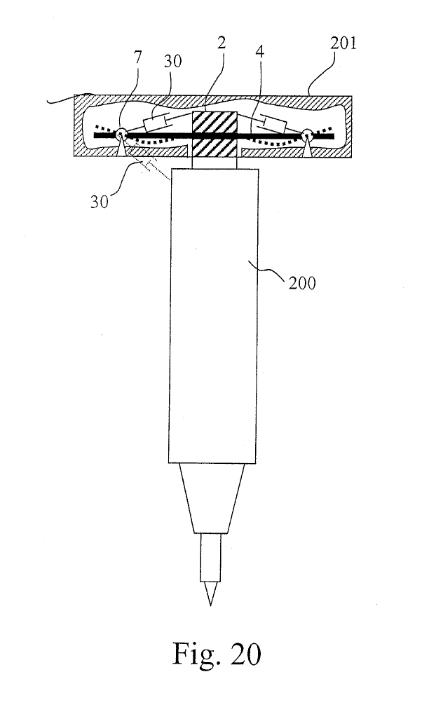

FIG. 20 is a schematic view of a pneumatic chisel of the invention, or the like,

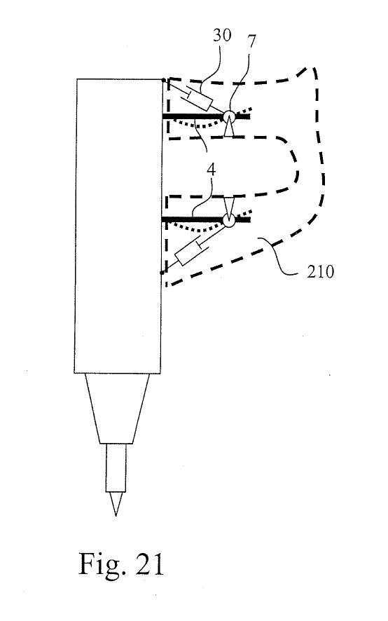

FIG. 21 is a schematic view of a roto hammer of the invention, or the like,

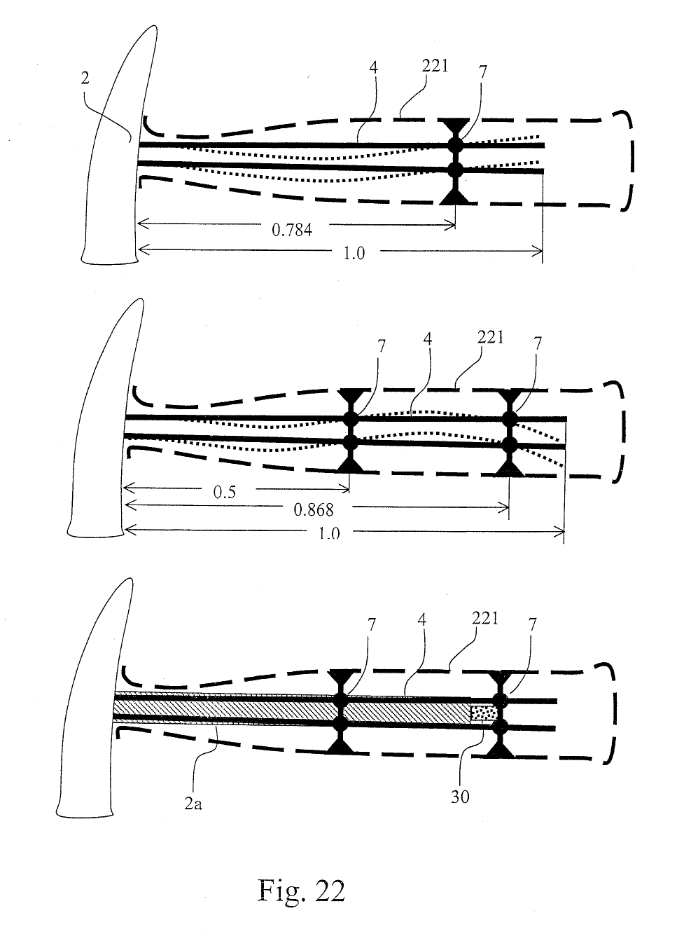

FIG. 22 is a schematic view of a hammer of the invention (illustration above with one oscillation nodal point, illustration in the middle with two oscillation nodal points, illustration below with damper),

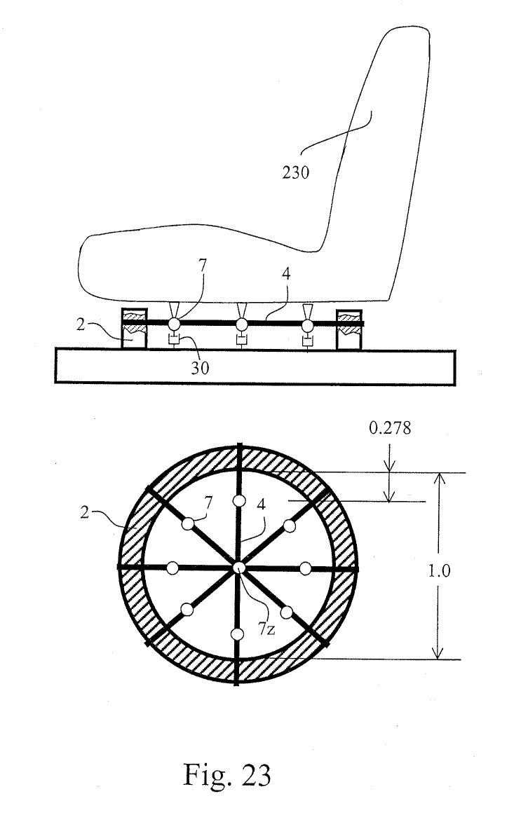

FIG. 23 is a schematic side view of an automotive seating (illustration above) and a schematic sectional view of the seat attachment (illustration below) according to a first alternative,

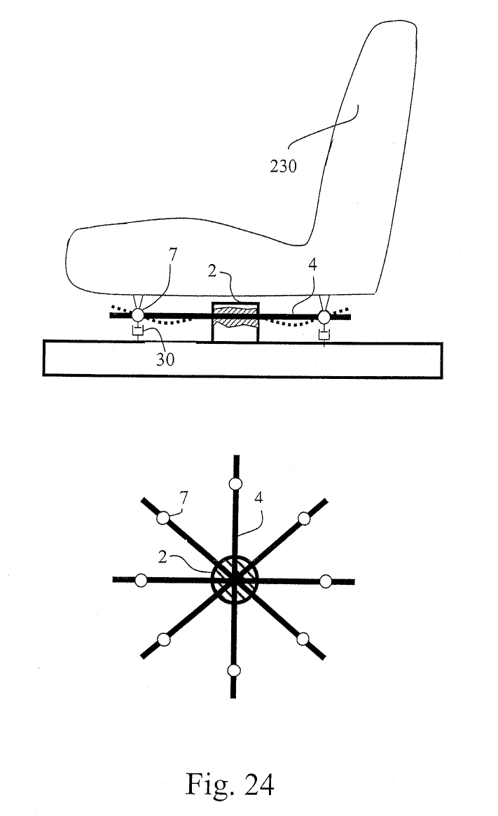

FIG. 24 is a schematic side view of an automotive seating (illustration above) and a schematic sectional view of the attachment (illustration below) according to a second alternative,

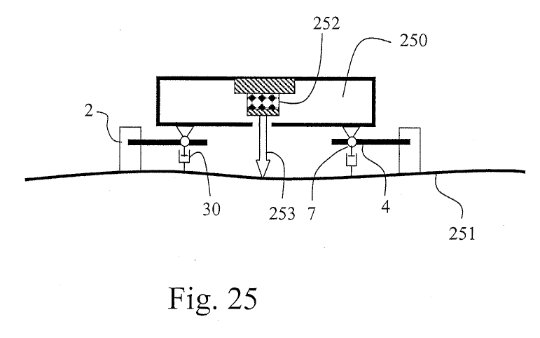

FIG. 25 is a schematic view of a measuring sensor of the invention, or the like,

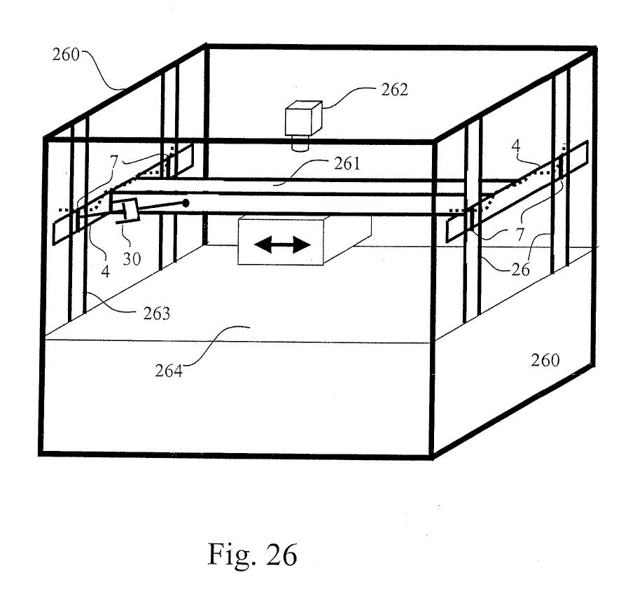

FIG. 26 is a schematic view of a machine frame of the invention,

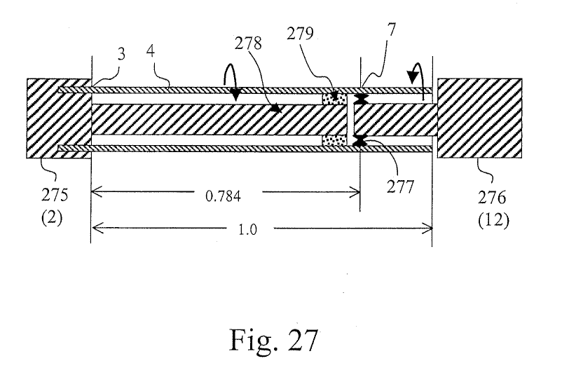

FIG. 27 is a schematic sectional view of a power train of the invention,

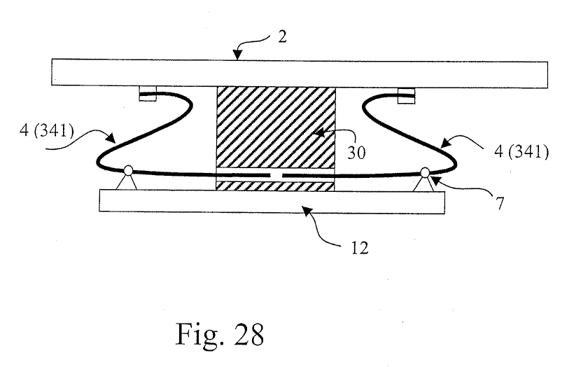

FIG. 28 is a schematic view of a twenty-third embodiment of the invention with three degrees of freedom,

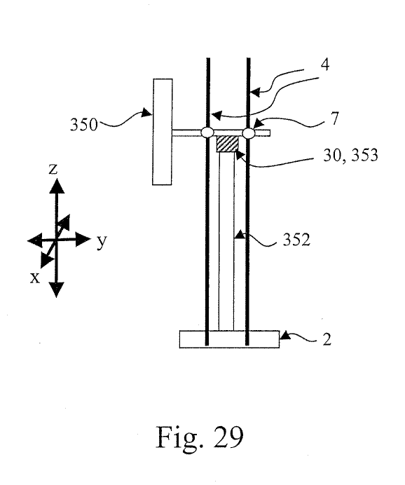

FIG. 29 is a schematic view of a twenty-fourth embodiment of the invention with two swinging elements,

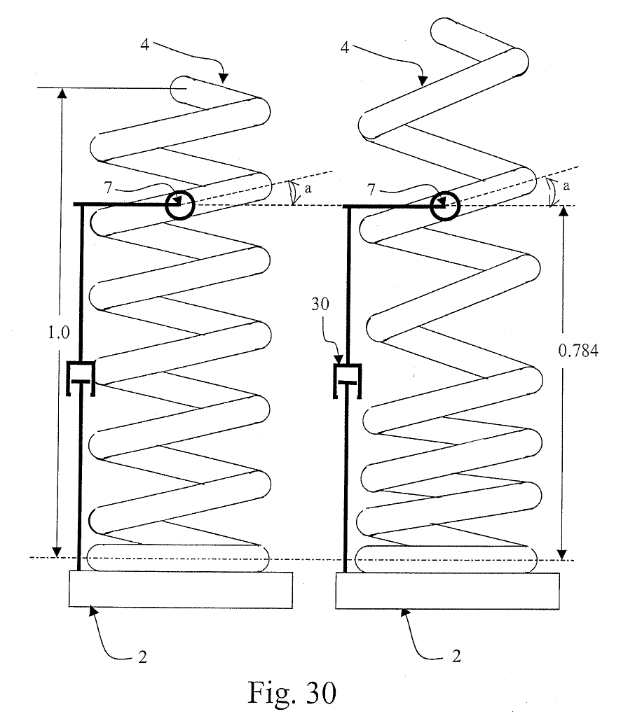

FIG. 30 is a schematic view of a twenty-fifth embodiment of the invention with longitudinal oscillations around an oscillation nodal point, shown in two different snap-shots (illustration left in zero setting, illustration right with larger amplitude),

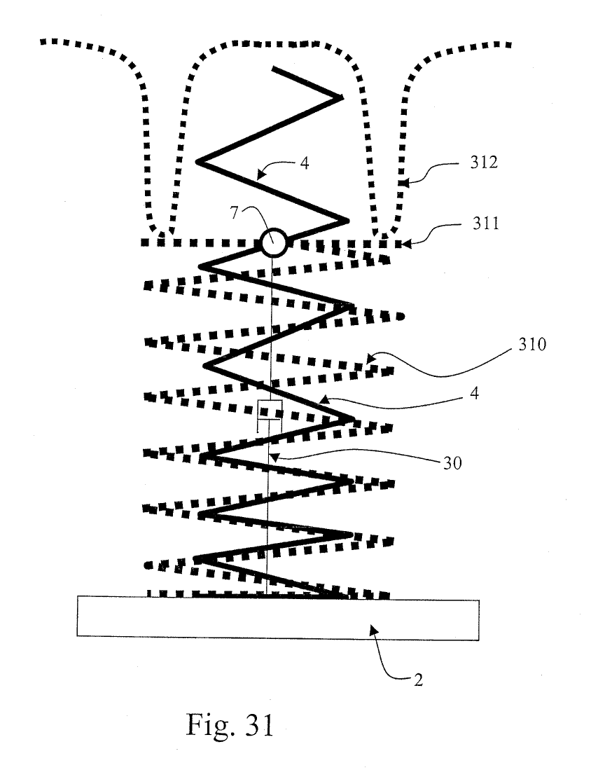

FIG. 31 is a schematic view of a wheel suspension by means of the twenty-fifth embodiment,

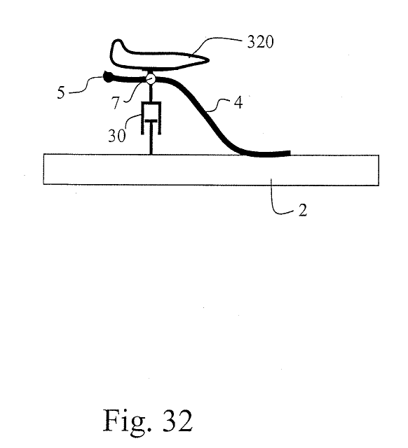

FIG. 32 is a schematic side view of a vehicle seat, in particular for a tractor,

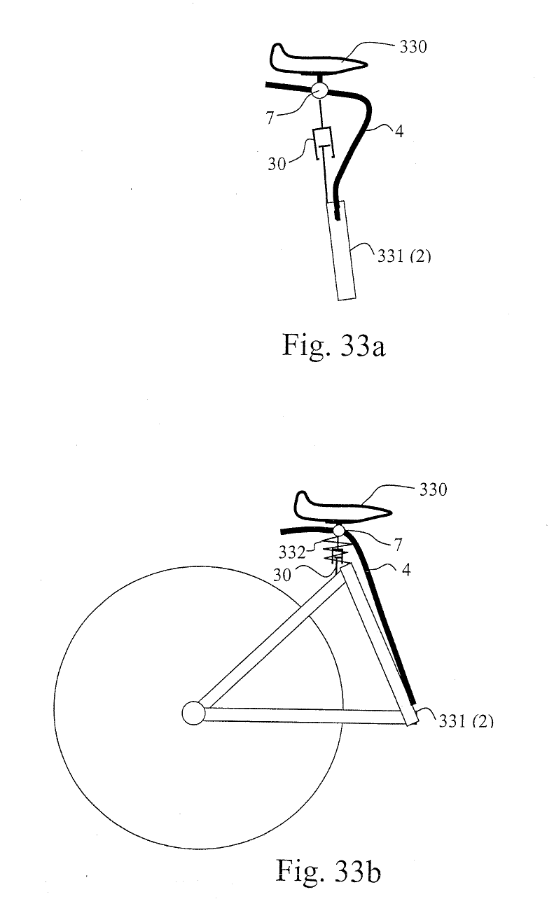

FIGS. 33a and 33b are schematic views of a bicycle seat,

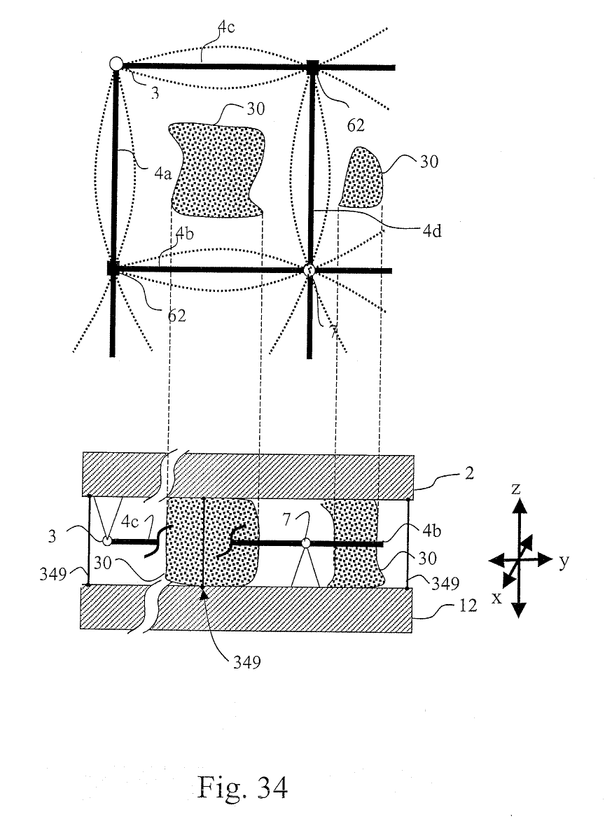

FIG. 34 is a schematic view of a two-dimensionally or three-dimensionally acting embodiment of the invention, which in view of its flat design may be used, e.g. as tool holder on a robot handling,

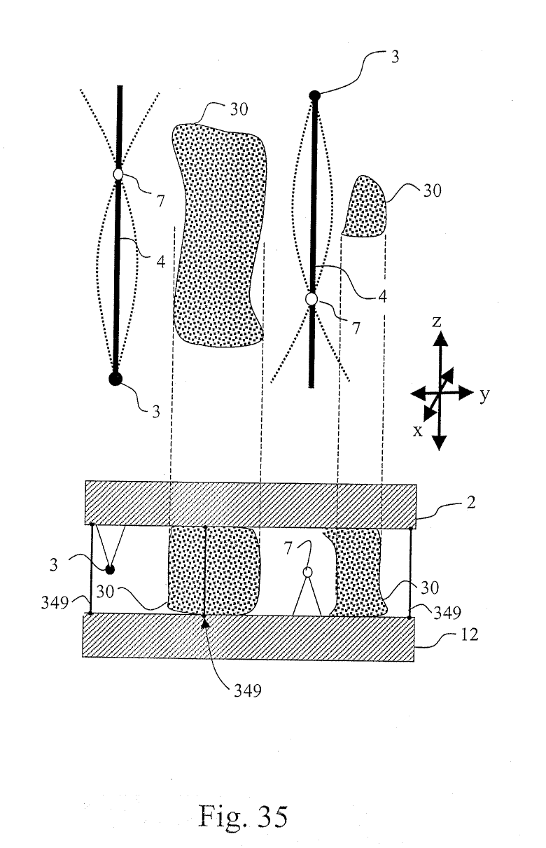

FIG. 35 is a schematic view of a one-dimensionally acting embodiment of the invention, which in view of its flat design, may, for example, be used as tool holder in a linear unit.

### Position of Oscillation Nodal Points:

With regard to a rod-shaped flexural oscillator (Biegeschwinger), the position of the natural oscillation nodal points in different oscillation modes is for example disclosed in the textbook H. Dresig, F. Holzweiβig: Maschinendynamik, Springerverlag, 5^{th} Edition, 2004, table 5.7.

For the one-sided attachment to a joint or for a one-sided restraint, the natural oscillation nodal points with an oscillation mode of the first harmonic lie at the 0.736 fold or 0.784 fold of the free rod length, see FIG. 1. The oscillator 4 in the left illustration is pivotably supported, in the right illustration firmly restrained (point 3). Many constructional problems may be more easily solved by using a fixed restraint, see the below mentioned examples. The mode of oscillation is shown by a dashed line. The first point 7 is the fixed oscillation nodal point of the first harmonic and is fixed, with or without the mass 12 pivotably supported in the first point (free oscillation nodal point). When the pivotable attachment of the mass is slightly shifted away from the position of the free oscillation nodal point, the oscillation nodal point moves along, depending on the volume of the mass and the degree of shifting. Thus, it is quite possible to use the mass to somewhat “shift” the oscillation nodal point. Therefore, the pivotable attachment must only be in the proximity of the free oscillation nodal point. To simplify the illustration, it will hereinafter be assumed that the pivotable attachment is located exactly in the free oscillation nodal point. By resonating additional weights (e.g. on the antinodes or in their proximity) the position of the free oscillation nodal points can be shifted.

When the attachment means 2 is jarred with an impulse in x- or y-direction (FIG. 1), the oscillator is excited to produce oscillations around the first point.

The energy induced by impulses or vibration is at least partially converted into oscillation energy of the oscillator, with the first point remaining at rest. Here, the orientation of the oscillator changes in the first point relative to the mass. Under ideal conditions, the position of the mass remains at rest, also under ideal conditions, the mass remains at rest in view of its inertia. The oscillator gradually releases the energy by inner friction or by additionally attached damping, not shown, without that the position of the first point changes (the impulse difference between respective two oscillations is small, besides, the algebraic sign of subsequent impulse differences alternates). Depending on the phasing, further impulses that are induced prior to decay, may further increase or reduce the oscillation, with the position of the first point being retained even in this case.

Which one of several possible modes of oscillation is adopted, although basically influenced by the exciting movement (“shock”), is essentially determined by the presence of masses with corresponding oscillation nodal points.

### Static Orientation:

Now, under real conditions, care must be taken that the orientation of the mass does not drift away. Depending on the application, this may be achieved by constructive means, as evident from the application examples mentioned below.

### Suppression of the Basic Oscillation:

Furthermore, under real conditions, the oscillation around oscillation nodal points is superimposed by a basic oscillation, see FIG. 2, left, with rotating restraint, an undesirably rigid pendulum movement, right, with fixed restraint, an undesirable flexural oscillation, each superimposed by the desired oscillation around the first point according to FIG. 1.

To suppress the basic oscillation, the present invention provides the following solutions.
1. Attaching a damping device, also called damping member, which is attached to the oscillator in the first point or at the mass, with an effective component lying in the direction of motion of the connecting point in case of basic oscillation.
2. Optionally, additionally attaching to the first point a classic dynamic vibration absorber (Tilger) which is attuned to the basic frequency.

By attaching a classic dynamic vibration absorber, the basic oscillation is effectively suppressed. According to the Applicant's experience, the classic dynamic vibration absorber without damping device must, however, be most carefully attuned to the basic frequency, otherwise interferences will occur which after several oscillation periods even lead to a temporary build up.

According to the invention, a damping device is used. In accordance with the invention, the damping member is on the one hand directly or indirectly attached to the first point, on the other hand, on the shock-afflicted structural unit 2. According to the Applicant's experience and contrary to expectation, it is possible to adjust the damping with simple means and in uncritical dimensioning in such a manner that the shocks, on the one hand, are not noticeably transmitted to the first point, and that, on the other hand, the basic oscillation is effectively dampened.

FIG. 3 shows, by way of example, for an arrangement similar to that of FIGS. 1 and 2, in schematic form the attachment of a damping element 30. It is attached, on the one hand, to the first point 7, and, on the other hand, to the shock-afflicted structural unit 2. By the diagonal form of attachment it is ensured that the damping member 30, effective in the direction 31, in addition to an effective component 32 (here: the z-direction), possesses an effective component in the direction 33 (here: the y-direction), the last-mentioned direction is the direction of motion of the first point in case of basic oscillation. Depending on the problem, the damping member may also be realized in a manner acting additionally or exclusively in the desired direction; in FIG. 3, a damping member 30a is depicted which acts directly in this direction, see also the application examples described below.

In the arrangement depicted in FIG. 3, one damping element, as depicted, is sufficient for shocks in the y-direction. For symmetrification, two symmetrical elements may be used (in FIG. 3 right, second element shown by a dashed line); for the damping of shocks also in x-direction, a further damper, not shown, can be used, which is in a diagonal slope to the drawing plane. Instead of the depicted damper, it is also possible to use a voluminously realized damper made of a plastically resilient substance (cf. Example FIG. 19A; explanation further below).

### EMBODIMENTS

### Oscillation Device:

As oscillators, elastic elements in the form of any known kinds may be used.

To increase resilience, e.g. rods may be replaced by coil springs (cylindrical form) or spiral springs, see Example FIG. 7A. This leads to a shortening of the oscillator while resilience remains the same or to an increase in resilience while the length remains the same, without that the wire diameter has to be reduced.

In Example FIG. 7B, the oscillator 4 consists of a coil spring and a rigid rod 71a connected therewith. The rigid rod 71b is part of the oscillator when it is pivotably supported in point 3, when fixedly restrained, it is not (then point 3 is situated further down at the beginning of the spring).

The oscillators may be oscillation plates, with the first points situated on the node lines of Chladni sound-patterns.

In case of several oscillation nodal points (a plurality of first points), and even in case of one oscillator only, the mass may be rotatably attached to these points, i.e. to several points; this is one of the construction methods to prevent the drifting away of the orientation of mass 12 relative to attachment 2, without having to use several oscillators. In the example of FIG. 6A the two nodal points are sufficient to stabilize a rod 12 in a statically determined manner.

From the point of view of construction, several oscillators may share a common first point, see e.g. the central point 7z in FIG. 23.

In the examples, the oscillators freely swing; however, they may also be embedded in at least partially elastic materials in a manner allowing swinging.

It is possible to use oscillators composed of a plurality of individual elements that are capable of swinging. An example with spring rod and coil spring is found in FIG. 18:

A camera 1 is to be attached to a structural unit 2 which vibrates at high frequency and/or undergoes abrupt accelerations, as indicated by the dotted lines. The coordinate system shall be with z along the optical axis, x and y at right angles thereto (x not shown, at right angle to y). Impulses along the optical axis lead only to minor changes in the image, what is serious, however, are the impact components in the x- and y-directions. The latter are compensated by the arrangement of FIG. 18.

Impacts on the contact point 3, in the x- or y-directions, lead to oscillations around the first point 7.

The oscillator is rotatably and low-frictionally attached to the contact point 3 and consists of a swinging rod 4, optionally with one or more auxiliary masses 5 attached to the swinging rod, and a retaining spring 6. Oscillator and mass may be rotated in the first point 7 in opposite directions. In FIG. 18, the mass 12 consists of camera 1 (with objective), holder 8 and counterweight 9.

First of all, the retaining spring 6 is destined to prevent the rod from falling down. It is part of the swinging system. When the elastic forces are selected such that the retaining spring is considerably softer than the oscillator, the arrangement according to FIG. 18 equally works for impacts in the x- and y-directions, even with one retaining spring only. This condition is favourable anyhow, since in that case the oscillation behavior is not influenced by shocks via the retaining spring. Of course, to symmetrify the dynamics it is also possible to arrange a plurality of retaining springs around the oscillator, e.g. also in form of a round membrane. A soft dimensioned return spring 10 stabilizes the orientation of the camera. However, preferably the orientation is achieved by parallel arrangement of arrangements according to FIG. 18.

### Restraint on Structural Unit:

The oscillation device may be restrained on the structural unit either rotatably (FIGS. 9, 12A, 13, 18) or fixedly.

In FIG. 9, for example, the shock impact takes place on a joint 3. FIG. 11 shows an arrangement with fixedly restrained oscillator, with absorption in the x- and y-directions. The swinging rod 4 is firmly restrained on contact point 3. The mass 12 is symmetrical as to rotation, thus no constructive means are required to prevent rotation around the first point 7.

### Rotatable Attachment:

On the first points, the rotatable attachments can be realized in any known kind of joints, for example as bearing, as blade or as element subjected to bending and/or torsion, such as a wire, pin, rod, coil spring, spiral or helical spring, short leaf spring, crossed leaf springs.

### Damping Device:

The damping elements in the Figures are symbolically depicted and may be realized in practice in any known manner, e.g. as hydraulic or pneumatic shock absorbers, as friction dampers, as damping body, in the form of damping material or as soft plastic, possibly elastically biased, material subjected to tension/pressure/shear strain (with regard to the latter see Example FIG. 19A). It is essential that an effective direction component is present which lies in the direction of motion of the connecting point in case of basic oscillation. Suitable as vibration compensator is, for example, a foam which dampens oscillations or absorbs vibrations.

### Auxiliary Masses:

To convert shock energy in oscillation energy, sufficiently swinging masses and amplitudes are required. To achieve this in particular in case of higher harmonics or miniature design, according to the invention, instead of individual auxiliary masses, also arrangements according to FIG. 7C may be used: On a comparatively thin elastic core material 700, auxiliary masses are beaded as on a string of pearls, 701a to 701c are examples. Core material 700 and auxiliary body 701a form together the oscillator 4. In case of 701a and 701c (FIG. 7C bottom center) the auxiliary masses are in point contact so that the bending of the oscillator is not hindered. In 701b (FIG. 7C bottom left) a damping disc 702 is located between the auxiliary masses being in flat contact with each other so as to reach a faster attenuation of the (intended) oscillations. Even in case the auxiliary masses on the core material have some clearance, this play results in a certain damping. In example 703 (FIG. 7C bottom right), the oscillator 4 is integrally formed and has distinct regular or irregular notches to increase resilience (preferably in places of strong bending during swinging) between thicker sections.

A similar effect is obtained when in accordance with the present invention the core material is wrapped with a wire, as known in principle from piano strings. If overall weight is to be reduced, larger auxiliary masses or layers of wire will be placed in the areas of the antinodes.

### Additional Dampers:

In order to enforce a not too long decay of the oscillator of the actually desired oscillations around the first point, it is possible to attach, preferably to the antinodes, unsupported damping means, such as containers filled with pellets or cladding/encapsulations with plastic damping material. The above mentioned discs 702 in FIG. 7C (bottom left) have the same function.

### Classic Dynamic Vibration Absorbers:

A classic dynamic vibration absorber (Tilger) only dampens a specific resonance frequency. In the arrangement presented here it is just the other way round: all frequencies are cancelled except (very low ones and) the basic frequency of the oscillator. In accordance with the invention, the mass of the so far described arrangements is provided with an additional spring-mass system as classic dynamic vibration absorber. For the example of FIG. 9, the arrangement of FIG. 13 is suggested; basic oscillations in the x- or y-direction are dampened by the additional oscillator 21 which is realized as resilient pendulum. The classic dynamic vibration absorber 22 provided with a coil spring acts primarily in the y-direction, a classic dynamic vibration absorber acting in the x-direction is not shown. Preferably, a classic dynamic vibration absorber arranged symmetrically circular around the table leg is used that is resiliently attached to the table leg, e.g. by means of a ring membrane.

FIG. 14 shows a corresponding extension of the arrangement of FIG. 10 by two classic dynamic vibration absorbers 22 for suppressing the basic oscillations of the swinging rod 4. The damping elements according FIG. 10 are preferably additionally present (not shown).

Especially advantageous is the combination of damping device and classic dynamic vibration absorber: even in a classic dynamic vibration absorber that is slightly out-of-tune, on the one hand, the first basic oscillation periods are suppressed by the classic dynamic vibration absorber with high force, and, on the other hand, the above described interference does not occur since after some oscillation periods, the oscillation is in any case suppressed by the damping. The damping of the basic oscillation of the oscillator and a damping of the classic dynamic vibration absorber are coordinated.

### Two Degrees of Freedom:

In case of unbalance of the oscillator, the position of the oscillation nodal points is in principle dependent on the oscillation direction. This will be explained on the example of bent rods, as used in some of the below mentioned examples. Cases may be realized where at least one oscillation nodal point is at least approximately independent from the orientation of the oscillation. When the oscillation nodal points only approximately coincide, owing to the above described effect of “shifting”, a common oscillation nodal point is forced by the mass 12.

FIG. 4 shows the position of the oscillation nodal points of a twice bent rod, for oscillations in the x-direction (left) and in the y-direction (right). The first points 7a1 and 7a2 are close to each other, the first points 7b1 and 7b2 are further apart. FIG. 5 shows the position of the oscillation nodal points of a once bent rod for oscillations in the x-direction (left) and in the y-direction (right). The first points 7a1 and 7a2 are situated close to each other, for the first point 7b1 no corresponding point 7b2 exists. FIG. 6A shows with a bent rod an example for an unsymmetrical object with the position of the oscillation nodal points being well independent of the direction. In case of multi-dimensional oscillation problems, preferably such nodal points are used which are situated close to each other relative to their dimension; via the mass they are then “shifted” to the same position.

### Three Degrees of Freedom:

FIG. 6B shows an oscillator geometry in which the oscillation nodal points 7 for all three coordinates lie close together. With such geometries, it is possible to realize arrangements of the present invention, which are effective in all three directions of the coordinate system. A further example is found in FIG. 28.

Torsional Absorption with Transversal Oscillator:

FIG. 12A shows a basic solution for the use of transversely swinging elements for the absorption of rotary shocks, as occurring for example in the power train of automobiles or in machine tools (“stripping”) or in screwdriver machines. A torque is to be transmitted from one structural member 15 to another structural member 16. The structural members 15 and 16 are, for example, the masses of a double-mass flywheel or the corresponding parts of a torsion-dampened clutch disk with masses attached thereto. In analogy to the previous Figures, in the present case structural member 15 functions as structural member 2, structural member 16 with the parts attached thereto as mass 12. The power transmission in the stationary state or in case of low-frequency torque variations occurs in a manner known per se resiliently, as symbolized by compression springs 20. In accordance with the present invention, there are provided on the circumference of the arrangements for the absorption of abrupt and high-frequency torque variations, comprising an oscillator 4, possibly together with auxiliary mass 5 (not shown), which is rotatably supported on the impact point 3, and, in case of rotational shocks oscillates around the first point 7. At the first point, the power transmission to the structural member 16 may take place directly via a joint in the first point 7 (FIG. 12A, left), or indirectly, cushioned by a power transmission spring 14, which is connected on the first point 7, on the one hand, with the oscillator, and, on the other hand, with the structural member 16 (FIG. 12A right). In the left oscillator, no spring 14 is used; preferably, but not necessarily, a symmetrical arrangement will be realized. The dimensioning of the spring constants and the elasticity of the swinging rod leads to a delimitation between low frequency torque variations to be conventionally absorbed and high frequency torque variations to be absorbed in accordance with the present invention. Damping elements 30 (partly not shown) introduced, if required, have a tangential component.

FIG. 12B shows two examples for a corresponding approach to a solution in case the swinging rod 4 is firmly restrained, above for the position of the first point as in FIG. 1 left, below for a higher oscillation mode, where on the free natural oscillation nodal points further masses 12 are attached, to support the tendency for oscillation in the desired mode. In this mode, natural oscillation nodal points lie in the case of fixed one-sided restraint, e.g. at the 0.35 fold, 0.64 fold and 0.91 fold of the length of the rod, see the above mentioned textbook table. On the first nodal point, the first point is found, on the other two there are found additional masses 12. The firmly restrained swinging rod takes along on the first point 7 with rotatable support the structural member 16, optionally indirectly via a spring 14. On the left shock absorber in FIG. 12B, direct power transmission is depicted, without spring 14.

Abrupt torque impulses are taken up by the swinging rod without that they are transmitted to the structural member 16. Of course, in this case too, preferably a plurality of shock absorber arrangements are realized on the circumference. The structural member 16 may serve as common mass for all shock absorbers. In view of the fixed restraint of the swinging rods, the soft torque transmission symbolized in FIG. 12A with springs 20 may in principle be dispensed with. Similar to FIG. 9, by using a thicker profiling near the contact point and a thinner profiling at the freely swinging end (continuous transition), a good power transmission on the one hand, and, on the other hand, a not too high resonance frequency are aimed at.

In the first point 7, the swinging rod 4 and the mass 16 rotate locally relatively to each other.

Torsional Absorption with Torsional Oscillator:

In accordance with the present invention it is also possible to use torsional oscillators for the absorption of rotatory shocks.

FIG. 27 shows an arrangement according to the present invention for the absorption of torsional oscillations and torsional shocks with drive shaft 275 and transmission output shaft 276. Between them a pipe is provided as torsion oscillator 4, the transmission output shaft (with the structural elements connected therewith) acts as mass. The pipe is either directly attached to the torsion oscillation nodal point 7 or circularly to the transmission output shaft (fastening means 277), so that the torsion oscillations (arrows) may rotate around the mass (local rotation around radial axes). A plastically deformable material 279 is located near the oscillation nodal point between the oscillator 4 and an extension 278 of the drive shaft 275. At this point, a friction damper may also be provided.

In the drawing, the fastening means 277 is shown inside the pipe (transmission output shaft inside pipe), but it may as well be outside (transmission output shaft outside pipe), or inside and outside. Of course, the opposite is also possible, namely that the oscillator is realized as full material and the output shaft as pipe surrounding the oscillator.

Advantageously, instead of by a pipe, the oscillator may be realized by several rods arranged in parallel as in FIG. 19A. It may also be replaced by one or more coil springs, preferably by intertwined coil springs according to FIG. 8. By such parallel connections, the stiffness of the individual elements is reduced, while the static capacity remains high in view of the parallel connection.

### Longitudinal Oscillators:

It is also possible to use longitudinal oscillators as arrangement according to the present invention. FIG. 30 shows such an example with longitudinal oscillations. A coil spring is depicted side by side in various oscillation states, with an oscillation nodal point existing in the first point 7. Point 7 is idle, the oscillator rotates locally in point 7 around point 7, which can be seen from the angle a which is different on the left and on the right. This can be used for example for a wheel suspension according to FIG. 31, see below.

A longitudinal oscillator according to FIG. 30 may also be simultaneously used as transversal oscillator according to FIG. 7A. Thereby it is possible to realize systems acting in all three coordinate directions.

### Parallel and Series Connections:

It is possible to connect arrangements according to the present invention in parallel and in series.

In particular, connecting oscillators in parallel allows a statically determined position and orientation of the mass.

An inventive approach to flattening the basic frequency-resonance curve is to connect in parallel a plurality of arrangements of the invention which have different resonance frequencies, effective for the various oscillators for the same or a different harmonic.

A parallel connection is particularly practical when a plurality of such devices have to be connected in parallel in any case. FIG. 8 shows an example of a parallel connection, having three intertwined coil springs (shown as continuous line, dashed line or dotted line), and having three first points 7a, 7b, 7c, which are located on a common plate 25 which serves as mass and to which the mass is attached. The position and the orientation of the plate and thus of the mass is determined via these three points.

FIG. 16 shows a parallel connection with swinging rods of diverse thicknesses, used for shock absorption in the x- and y-directions. The swinging rods have a resonance frequency depending on their thicknesses.

FIG. 17 shows the in-series connection of two such arrangements, with the first one having horizontal swinging rods 4a acting in the z-direction (the second arrangement and its actual load acts as mass for the first one), the second arrangement corresponds to FIG. 16 and thus acts in the x-y directions. The x-y-z impacts are introduced on structural member 2a. The oscillators 4a of the first arrangement rest rotatably on their contact points 3a and are connected via stilts 21 with the structural member 2b on their first points 7a. The oscillators 4a absorb impulses in the z-direction. The stilts are used in this special case to allow the oscillators 4a to swing freely (this would not be the case if the structural member 2b were a frame instead of a plate). The shock absorption in the x-y-directions is effected as in FIG. 10 by means of an oscillator 4b, with contact points 3b and first points 7b.

To simplify the drawing, in FIGS. 16 and 17 opposite oscillators were not shown. In practice, the rods 4a will sag slightly (harmless). In FIGS. 16 and 17 swinging rods with square cross-section are shown to simplify the engineering drawing; for reasons of symmetry, however, round rods are to be preferred.

Arrangements according to FIGS. 16 and 17 may, for example, be used for the shock-absorbing mounting of cameras or hard disks, by directly or indirectly attaching them to the parts drawn as mass 12 or 12a; when firmly mounted, they form, of course, part of the mass. The same arrangement or similar ones may be used in buildings between the foundation and the ground plate of the building for earthquake protection.

FIG. 15 shows an example of rotatory shock absorption according to FIG. 12B above, wherein a plurality of shock absorbers with different resonance frequencies are used, which are realized in the example by means of differing rod thicknesses and rod lengths. Of course, it is also possible to realize different resonance frequencies via other geometrical variations, different materials or different auxiliary masses or combinations thereof.

FIG. 19A shows an arrangement with three parallel rod oscillators 4 which are firmly restrained on top on a holder 2. The rods' oscillations are shown by a dashed line. The parallel depicted rods are advantageous, but parallelism is not necessary. On a lower plate 190, three oscillators 4 are pivotably attached to the three first points 7. In practical experiments, a pivotal attachment of the rods by means of horizontal flexible strips has proved of value, which strips are vertically pierced and stretched over comparatively large recesses in the plate 190. The damping elements 30 are diagonally attached between the upper and the lower plate. To simplify the drawing, only two of preferably three damping elements are shown, which are somewhat offset at the perimeter or provided with folds so that they do not contact each other in the center. The actual mass 12, e.g. a camera directed downwardly, is directly attached to the plate. Horizontal vibrations are suppressed by the system, but vertical ones are not. In this camera orientation, vertical movements are noncritical. In particular with long focal widths they do not lead to wiggly images, while in this case horizontal movements are especially critical.

The dampers shown need not directly contact the first point; they may also be indirectly connected with the first point via the plate 190 (shown as dashed line: 30x).

The dampers shown can also be replaced by a plastically flexible mass which is attached between the plates with recesses for the swinging rods (e.g. sector-shaped recesses according to FIG. 19A below).

FIG. 19B shows the same arrangement, but with oscillators 4 according to FIG. 6B. In this arrangement, the oscillators may receive impacts from all three directions (x,y,z), with the first points here being at rest again. In contrast to FIG. 19A and other arrangements, the first points 7 have three translatory degrees of freedom: the points can be shifted by a force in all directions, while in FIG. 19A this is not the case for the z-direction. Details on dimensioning can be taken from the following description of the two-dimensional representation in FIG. 19C (two-dimensional to simplify the drawing): By a short shock (in any direction), basic oscillations may be produced which are to the be absorbed by the damping element 30. If the damping element is adjusted too hard (extreme case: rigid element), it tends to retain its length, so that the first point 7 will move on the circle 191 shown by a dot and dash line; the oscillator 4 will thereby be shifted above into the situation 4a represented by a dotted line, the damping element 30 will be shifted into the situation 30a shown by a dotted line, the first point 7 will be shifted into position 7a. In case the damping element is adjusted very softly, it rather tends to change its length, thus the first point 7 will move in correspondence with the natural basic oscillation of the oscillator, as indicated by the situation 4b of the oscillator and the layer 30b of the damping element which are represented by long dashes (first point in position 7b). The damping element thus must, on the one hand, be sufficiently strongly adjusted to be sufficiently effective in damping the basic oscillation, on the other hand, the force caused by the change in length of the damper (also taking into account the velocity/ies (Geschwindigkeitsverhältnisse)) must not be higher than the elastic force required for the layer shown as dotted line.

FIG. 6c shows a series connection of two (rod-shaped) oscillators, the first oscillator (61a) and the second oscillator (61b), which are connected with each other at a point (62), depending on the application in a rigid or rotatable manner. In case of a rotatable attachment, rotationally acting auxiliary springs (not shown) can be used at the rotational point for securing the static situation. In case of a rigid connection, the oscillators are preferably adapted to the same oscillation frequency and particularly preferably have the same geometry, as shown in the drawing. In this case, the first oscillator (61a) is preferably clamped rotatably at point 3. The mass 12 is connected rotatably with the second oscillator at point 7.

In case of impacts on the structural unit 2 in the y-direction, the first oscillator is excited. In case of impacts in the z-direction, the second oscillator is excited. In case of impacts in the x-direction or impacts occurring at an angle with respect to the coordinate axes, both oscillators are excited. In case of a rigid connection (62), the system tends to behave as shown in the drawing if both oscillators oscillate together: Both oscillators change together between the dotted and the dashed positions. Although being connected rigidly (62), the second oscillator behaves in the same manner as it would behave when being an individual oscillator that is clamped rotatably.

FIG. 34 shows a parallel connection of two arrangements connected in series according to FIG. 6c, having a common point 3 and a common first point 7 (top: top view, bottom: side view, cut on the left approximately at the height of oscillator 4c and on the right approximately at the height of oscillator 4b). The four (rod-shaped) oscillators 4a, 4b, 4c, 4d are arranged in a horizontally oriented manner between structural unit 2 and structural member 12. The structural unit is connected with oscillators 4a and 4c at point 3, the structural member is rotatably connected with oscillators 4b and 4d at the first point 7. Between structural unit and structural member there is/are one or more damping means 30, here in the form of an at least partially plastically deformable material or also in the form of surfaces rubbing against each other (the latter version is not shown). The damping means can also at the same time represent a power connection being active in the z-direction in order to (a) prevent contact between the oscillators and the structural member or structural unit in case of a standing arrangement (structural member stands on the structural unit as a base) or (b) prevent falling down of the structural member in case of a hanging arrangement (structural member hangs on the structural unit). In order to prevent this reliably, holding elements 349 reacting to pressure or tension can additionally be provided between structural unit and structural member. The holding elements act essentially in the z-direction and are bendable in the x- and y-directions. Instead of holding elements, also a horizontal (x-y) guidance of structural unit and structural element can be used. Instead of holding elements, the oscillators can also be bands (leaf springs) having an at least approximately rectangular cross section, with a clearly larger extension of the rectangle in the z-direction. In case of symmetrical oscillators without holding elements and without guiding, the arrangement acts in all three coordinate directions; otherwise, the arrangement acts at least in the x- and y-directions. The arrangement allows a very flat design (much flatter than shown in the drawing) being effective in two or three coordinate directions.

It is not necessary that the oscillators, as shown, are at a right angle with respect to each other. The oscillators can be bent, also into the drawing plane.

Because of its flat design, the arrangement can be used, e.g., as a tool holder on a robot handling or x-y table.

FIG. 35 shows a schematic view of an embodiment of the invention acting one-dimensionally (in the y-direction), according to the design of FIG. 34, but with oscillators attached in an anti-parallel manner. Because of its flat design, the arrangement can advantageously be used, e.g., as a tool holder on a linear unit.

It turned out that arrangements having a slightly unsymmetrical design (e.g. according to FIGS. 19A/19B, explanation below) tend to undergo rotating vibrations (with nevertheless stable center position). In order to avoid an exact symmetrification, the rotational vibrations can also be prevented by providing an arrangement according to FIGS. 12A/12B/15 after the arrangement, basically by providing a rotational classic dynamic vibration absorber after the arrangement.

When being connected in series, the second arrangement can be dimensioned such that it simultaneously acts as a classic dynamic vibration absorber for the first arrangement. Due to the connection in series, the shock absorption effect (incidental amplitude) of the individual arrangements is multiplied.

The preferred embodiments described above can be combined with each other as desired. According to the invention, these embodiments are described in the following for different applications.

### Applications

### Hard Disk etc.:

In one application the structural unit is a housing and the structural member a data storage means, such as an electronic, magnetic, optical or magneto-optical data storage means, in particular a hard disk storage means or drive for disc storages such as CD and DVD. Preferably, a plurality of oscillator devices connected in parallel and each having three degrees of freedom and a damping element of deformable material are used, see FIG. 28. This leads to a flat design and a low-priced damping. Further examples for a realization are shown in FIGS. 16 and 17.

### Camera, Mirror, etc:

In one application the structural unit is a frame or a vehicle, and the structural member is an optical means, such as an image capturing means, in particular a camera, an optical ray means, in particular a laser, or a mirror. For mirrors of vehicles, preferably at least two uniform oscillating elements being connected in parallel are used. The design can correspond to that of FIG. 19A or 19B. A further arrangement of the invention comprising two oscillating elements is shown in FIG. 29: In the structural unit 2, here the vehicle, e.g. on a handlebar of a motorcycle, two oscillating elements are attached and at the nodal points thereof a rear-view mirror 350 is rotatably attached. This way of attachment is advantageous in that in case of oscillations about the x-axis, the mirror is moved in the parallel direction without any change in the orientation. In case three oscillating elements are used, such as in FIG. 19, this is true for all axes. Vibrations and impacts in the x- and y-directions are absorbed by the oscillators. The damping element is realized by a viscous material 353 being connected with the structural unit via an elongation 352.

### Hammer Drill and the Like:

In one application the structural unit is a hand-held tool, such as a compressed air hammer, an electronic chisel, an impact drilling machine or a bolt-firing tool or the like, and the structural member is a retaining part, in particular a handle (aim: avoiding damage to the health). The oscillating means is preferably provided within the handle. This is advantageous in that contact with the oscillating means is avoided and a possible incorrect use is excluded.

FIG. 20 shows a compressed air chisel 200 or the like which is operated by two hands and the handle 201 of which is protected against vibration by means of an arrangement according to the invention, wherein the oscillating parts are provided in the handle for contact protection.

FIG. 21 shows an impact drilling machine, an electronic chisel, a bolt-firing tool or the like, the handle of which is protected against vibration by means of an arrangement according to the invention (oscillator firmly clamped in the device), wherein the arrangement is provided in the handle 210 in accordance with the invention.

### Hammer and the Like:

In one application the structural unit is a hammer head and the structural member is the handle of the hammer; oscillating means and damping means are provided in the hammer handle, which allows a compact design.

FIG. 22 shows a simple hammer or the like, the handle 221 of which is protected against vibration by means of an arrangement according to the invention. In detail, two oscillating rods 4 are firmly attached to the hammer head 2. In the region of the free nodal point (top of Figure) or the two nodal points (middle and bottom of Figure) of the two oscillating rods 4, the handle 221 is rotatably mounted at connection points 7. In the bottom of FIG. 22, the damping element 32 is shown. It consists of a plastic material which is connected with the hammer head 2 via a fixed elongation 2a being as stiff as possible. The two oscillators 4 are firmly clamped at the hammer head. This arrangement comprising two oscillating rods is advantageous in that the static position is predetermined even if the handle is rotatably mounted.

### Laboratory Bench and the Like:

In one application the structural unit is the base of a frame or a table, in particular a laboratory bench, and the structural member is the frame or table, wherein in the latter case the oscillation device is preferably provided in the table leg, giving the table an elegant appearance. This is advantageous in that contact with the oscillation device is avoided and a possible incorrect use is excluded.

FIG. 9 shows a standing oscillating rod 4, i.e. an arrangement for absorbing horizontal impacts in the leg of a laboratory bench acting as mass 12. If the table is sufficiently rigid, it is a common mass for possibly several legs. At least at its bottom end, the table leg is hollow, and in said hollow space the oscillator consisting of oscillating rod 4 and optionally one or more auxiliary masses 5 is provided. On the bottom end, the oscillating rod bears the weight of the table and is slightly reinforced. On the contact point 3, the oscillating rod 4 stands in a freely rotatably supported manner on the structural member 2. Because of the reinforcement and because of the auxiliary mass 5, the first point is shifted downwardly as compared to the standard case (left of FIG. 1). Because of the otherwise instable equilibrium, return springs 10 are provided. Shocks on the structural member 2 acting in the x- or y-direction are absorbed by the oscillator. If necessary, a possibly occurring basic oscillation is prevented by damping elements 30 having a horizontal effective component and at least approximately starting at the first point 7. Here, the shown damping elements do not act directly at the first point but indirectly via a first structural member 901.

An example for absorbing vertical impacts is shown in FIG. 10, comprising an oscillator 4 being clamped on both sides and two first points 7, and the mass 12. The mass 12 might, e.g., be a table leg which is to be secured against vertical shocks. A bending possibly caused by gravity is not shown in the drawing.

Arrangements according to FIGS. 9 and 10 can be connected in series so that impacts in all three directions in space are dampened.

### Vehicle Seat:

In one application the structural unit is a vehicle and the structural member a vehicle seat.

FIG. 23 shows a vehicle seat 230 or the like which is protected against vertical impacts and high-frequency vibrations by means of an arrangement according to the invention. A plurality of crossed rod-shaped oscillators (e.g. flat steel) are firmly clamped in a ring-shaped holder. Instead of a ring and a crossed rod structure, of course also “Cartesian” shapes with rectangular clamping 2 and parallel (crossed) oscillators are possible. In order to increase the mounting safety, the rods can be replaced by a plate (optionally having holes for increasing flexibility), wherein the first points are located on the node lines of Chladni sound-patterns. FIG. 24 shows an alternative arrangement for special applications in which this construction leads to a desired soft basic suspension.

An arrangement of a vehicle seat according to the invention for an agricultural machine, such as a tractor or the like, is shown in FIG. 32. An arrangement according to the invention for a bicycle is shown in FIG. 33a and FIG. 33b, having a slightly different geometry, wherein advantageously the bicycle seat is supported by an additional resilient means 332 (e.g. a coil spring, in parallel with respect to the damping element, only shown in FIG. 33b). This additional resilient means absorbs substantially the static weight of the driver, while the oscillator absorbs in addition to the static weight also the impacts (see also spring 20 in FIG. 12a or spring 310 in FIG. 31, description below). Spring 332 and damper can be realized in combination as a common structural element, e.g. as a spring with plastic material embedded between the turns.

### Frame of Automatic Handling Machine:

In one application the structural member is a frame and the structural unit is the movable part of a handling device attached to the frame.

FIG. 26 shows a machine frame 260 to which a linear axle 261 is attached by means of an arrangement according to the invention. By abruptly braking or accelerating the axle, impacts are generated which cause swaying movements of the frame which are harmful if, e.g., oscillation-sensitive devices (e.g. a camera 262 directed at the working field 264) are mounted on the frame. The arrangement according to the invention absorbs the swaying movements, and moreover the impact on the frame material, the hall ground, etc, is reduced. The two oscillators 4 are configured as resilient bands (leaf springs), with the first point 7, where they are attached with perpendicular rotational axis to the vertical elements 263. The oscillations are shown in dashed lines. Only one of the damping elements is shown. With the same or analogously modified structures, the same effect is of course also achieved in frame-mounted robots, band stoppers, pneumatic cylinders, etc.

### Output Shaft:

In one application the structural unit is a first rotating means, such as an input or driving shaft, preferably of a vehicle, and the structural member is a second rotating means, such as an output or driven shaft. To this end, arrangements having transversally oscillating elements according to FIGS. 12A, 12B, 15 (description see above) can be used or arrangements having torsional oscillators according to FIG. 27.

### Microphone and the Like:

In one application the structural member is an acoustic sensor, such as a microphone, oscillation meter, seismograph, hearing apparatus or the like, and the structural unit is a means to which the structural member is attached. In hearing apparatuses, in particular of the in-ear type, there is the problem of isolating structure-borne sound of the housing as well as possible from the microphone in order to prevent acoustic feedback. Thus, the microphone is suspended in a well-dampened manner in the hearing device. Also the undesired transmission of structure-borne sound (bone) to the microphone is suppressed in this manner.

Conversely, the arrangement according to the invention is particularly advantageous for receiving structure-borne sound of the structural unit itself.

FIG. 25 shows a measuring receiver 250 (measuring tip or measuring ray 253, measuring means 252, e.g. piezo crystal), e.g. a microphone for sound transmitted through the air or sound transmitted through the water or the like, comprising an impact- and vibration-damping holding means according to the invention for suppressing noise signals from the holding means. The Figure specifically shows the particularly interesting case in which the structure-borne sound of the specimen 251 is received, i.e. of the part at which the receiver itself is attached. In view of this problem, vibrations of the specimen which are also joined in by the measuring receiver, cannot be detected. This effect is avoided by the arrangement according to the invention.

### Loudspeaker:

In one application the structural unit is a loudspeaker and the structural member is the means to which the loudspeaker is attached. Thus, the resonances of the parts to which the loudspeaker is attached or with which it is directly or indirectly connected—and which are as a rule not predictable—are suppressed.

### Engine Support:

In one application the structural unit is an engine and the structural member is a chassis or the housing of a device. This leads to a reduction in the vibrations of the chassis or housing and thus also in the related sound emission. In cases in which no or only slight vibrations are caused along the engine axle, the oscillating means advantageously comprises only two degrees of freedom in the plane perpendicular with respect to the engine axle for reasons of complexity and stability.

A solution for cases in which three degrees of freedom are necessary is shown in FIG. 28. In said Figure, the oscillators 4 have three degrees of freedom with nodal points approximately overlapping at point 7. In this particular structure, the oscillators partially lie in a cavity of the damping element 30, which in this case is made of a plastically deformable material. The structure also allows a flat design for three degrees of freedom. The structural member is drawn in a hanging manner and when reversing it, it can of course also be drawn in a standing manner.

### Wheel Suspension:

In one application the structural unit is a wheel hub or a vehicle axle and the structural member is a chassis. In this case, preferably an oscillating means performing longitudinal oscillations is used (see FIG. 30). The arrangement advantageously requires approximately the same installation space as the normal arrangement comprising a coil spring, and the vehicle dynamics are not changed considerably.

An exemplary application is a wheel suspension according to FIG. 31. Oscillator 4 is a longitudinal oscillator according to FIG. 30, wherein instead of a coil spring of course also a barrel spring, banana spring, spiral spring or any other longitudinally oscillating elastic element can be used. At the first point 7, a connecting element 311 is attached in a rotatable manner, the chassis 312 rests on the connecting element. The damping means 30 connects point 7 with the structural unit 2 and can be realized in principle as a conventional shock absorber. Advantageously, a spring 310 is additionally used, which absorbs the major part of the static load, while the oscillator 4 absorbs in addition to the static weight also the impacts. The connecting element 311 can be a spring plate resting on the spring 310 and having a hole at point 7 for realizing a rotary connection with the oscillator 4. For the purpose of symmetry it might be reasonable to use intertwined springs 4 according to FIG. 8.

### Sound-Absorbing Intermediate Layer:

In one application the structural unit is a sound generator, such as a vibrating machine or a musical instrument, in particular a piano or a grand piano, and the structural member is a base on which the structural unit stands.

The base is in particular the floor, in most cases an intermediate floor which is capable of vibrating. The arrangement prevents or reduces the propagation of annoying structure-borne sound through the building.

### Final Remark:

The embodiments of the applications are examples. The patent application claims further applications and embodiments which are not mentioned, as far as they can be taken from the respective problem and the combination of claims, description or examples with the prior art. In particular, individual features of the different embodiments can be interchanged or combined with each other.

I claim:

1. Apparatus for connecting a structural member with a structural unit comprising: a) at least one oscillation device coupled to said structural unit and said structural member, where the oscillation device has a specific natural oscillation characteristic wherein at least one oscillation nodal point is formed when excited by impulse or vibration, b) wherein the structural member at the oscillation device is arranged on at least one connecting point which is situated on or near the oscillation nodal point(s), and c) at least one damping device for damping a basic oscillation of the oscillation device relative to the structural unit.

2. Apparatus according to claim 1, wherein the structural member is rotatably attached to the oscillation device.

3. Apparatus according to claim 1, wherein the damping device is directly or by means of a first structural element attached to the oscillation device on or near one of the oscillation nodal points.

4. Apparatus according to claim 3, wherein the damping device is connected with the structural unit such that the damping device has an effective component which in basic oscillation lies in the direction of motion of the connecting point.

5. Apparatus according to claim 1, wherein the oscillation device comprises at least one elastic element, the configuration and/or mass of which is selected such that the energy induced by impulse or vibration is at least partially converted into oscillation energy of oscillation around oscillation nodal points.

6. Apparatus according to claim 1, wherein the oscillation device comprises at least one elastic element, such as a bending rod, preferably with a circular cross-section, a coil spring, a leaf spring, a spiral (or helical) spring, an oscillation plate or another structural member from elastic material, such as rubber, or combinations of such elastic elements.

7. Apparatus according to claim 6, wherein the oscillation device comprises at least one rigid element.

8. Apparatus according to claim 1, wherein the oscillation device comprises at least one piece having notches that increase elasticity, preferably in places of strong bending during oscillation.

9. Apparatus according to claim 1, wherein the oscillation device comprises three intertwined coil springs or spiral springs, each having one connecting point.

10. Apparatus according to claim 1, wherein the damping device comprises an hydraulic damper or an air damper which can be modified in length.

11. Apparatus according to claim 1, wherein the damping device acts by friction between two structural members movable to each other, in particular in form of an opposite rotating motion.

12. Apparatus according to claim 1, wherein the damping device comprises a body of deformable material, preferably foam, damping the oscillations.

13. Apparatus according to claim 1, wherein the oscillation device comprises at least one auxiliary mass which is arranged on said oscillation device in such a way that a particular natural oscillation characteristic results.

14. Apparatus according to claim 13, wherein the oscillation device comprises an elastic core material on which a plurality of auxiliary masses is arranged, preferably at a distance from each other, and wherein preferably damping elements are arranged between the auxiliary masses.

15. Apparatus according to claim 13, wherein at least one of the auxiliary masses is arranged on or near at least one of the antinodes on the oscillation device.

16. Apparatus according to claim 1, wherein the oscillation device comprises at least one damping means, which is preferably arranged on or near at least one of the antinodes on the oscillation device, and wherein the damping means comprises a container filled with oscillation-absorbing material or a cladding of the oscillation device consisting of oscillation-absorbing material.

17. Apparatus according to claim 1 comprising a translation or rotation classic dynamic vibration absorber which is directly or by means of a second structural element attached on the oscillation device on or near one oscillation nodal point and tuned to the basic oscillation of the oscillation device.

18. Apparatus according to claim 1, wherein the oscillation device is moveable in at least two oscillation directions and shows a specific natural oscillation characteristic for each of the two oscillation directions, wherein for each of the two oscillation directions at least one oscillation nodal point is formed upon excitation by impulse or vibration and at least one each of the oscillation nodal points of the two oscillation directions forms an at least approximately shared oscillation nodal point.

19. Apparatus according to claim 1, wherein the oscillation device is moveable in three oscillation directions and shows a specific natural oscillation characteristic for each of the three oscillation directions, wherein for each of the three oscillation directions at least one oscillation nodal point is formed upon excitation by impulse or vibration and at least one each of the oscillation nodal points of the three oscillation directions forms an at least approximately shared oscillation nodal point.

20. Apparatus according to claim 1 for absorption of rotatory shocks or vibrations, comprising at least one, preferably a plurality of radially oriented oscillation devices which may perform transversal oscillations in the rotational direction.

21. Apparatus according to claim 1, wherein the oscillation device comprises at least one elastic element acting as torsion oscillator.

22. Apparatus according to claim 21, wherein the torsion oscillator comprises an elastic element which generates torsion oscillations relative to one axis, such as a rod, a tube, a coil spring, a spiral spring and/or combinations of at least one of these elastic elements with at least one rigid element.

23. Apparatus according to claim 21, wherein the torsion oscillator comprises a plurality of oscillating rods which are arranged in parallel.

24. Apparatus according to claim 1, wherein the oscillation device is capable of exhibiting longitudinal oscillations having oscillation nodal points.

25. Apparatus according to claim 1, wherein at least two oscillation devices are arranged in parallel and/or in series.

26. Apparatus according to claim 25, wherein a first oscillation device operates at a first resonance frequency and a second oscillation device connected in parallel operates at a second resonance frequency which is different from the first resonance frequency.

27. Apparatus according to claim 1, wherein a first apparatus according to claim 1 and a second apparatus according to claim 20 are connected in series, wherein rotatory shocks or vibrations remaining from the first apparatus are absorbed by the second apparatus.

28. System comprising a structural unit and a structural member which is attached to the structural unit by an apparatus according to claim 1.

29. System according to claim 28, wherein the structural member is a data storage means, such as an electronic, magnetic, optical or magneto-optical data storage means, in particular a hard disk storage means or drive for disk storage, such as CD and DVD, and wherein the structural unit is a means on which the data storage means is directly or indirectly attached, in particular its housing.

30. System according to claim 29, comprising at least one oscillation device according to claim 19, preferably a plurality of such oscillation devices connected in parallel, and preferably a damping element according to claim 12.

31. System according to claim 28, wherein the structural unit is a chassis, vehicle or the moveable part of a handling system, such as that of a robot or a traversing axis, and the structural member is an optical means, such as a capturing means, in particular a camera, or an optical beaming means, in particular a laser, or a mirror, or a tool, such as a milling head, a printhead, a welding machine or a wire feeder.

32. System according to claim 31, wherein the structural unit is a vehicle and the structural member is a vehicle mirror, comprising at least two, preferably three similar oscillation devices connected in parallel.

33. System according to claim 28, wherein the structural unit is a hand-operated machine tool, such as a jackhammer, an electric chisel, a roto hammer or a powder-actuated tool, and wherein the structural member is a holding member, in particular, a handle.

34. System according to claim 33, wherein the oscillation device is located inside the holding member.

35. System according to claim 28, wherein the structural unit is a hammer head, and wherein the structural member is a hammer handle, the oscillation device is situated in the hammer handle, with the oscillation device having two bending rods on which the hammer handle is pivotably attached, and wherein preferably a damping device according to claim 12 is provided in the hammer handle.

36. System according to claim 28, wherein the structural unit is the base for a support frame or a table, in particular, a bench, and the structural member is the support frame or table, with, in the latter case, the oscillation device preferably being provided in the table leg.

37. System according to claim 28, wherein the structural unit is a vehicle and the structural member is a vehicle seat.

38. System according to claim 37, wherein the vehicle is a bicycle and the vehicle seat is a bicycle saddle, with the bicycle saddle being preferably supported by an additional resilient means.

39. System according to claim 28, wherein the structural member is a support frame and the structural unit is the moveable part of a handling device which is directly or indirectly attached to the support frame.

40. System according to claim 28, wherein the structural unit is a first rotating means, such as a drive shaft, preferably of a vehicle, and the structural member is a second rotating means, such as a transmission output shaft.

41. System according to claim 28, wherein the structural member is an acoustic sensor, such as a microphone, an oscillation measuring means, a seismograph, an acoustic hearing apparatus or the like, and the structural unit is a device on which the structural member is attached.

42. System according to claim 41, wherein the sensor is designed for capturing structure-borne sound from the structural unit.

43. System according to claim 28, wherein the structural unit is a loudspeaker and the structural member is the device on which the loudspeaker is attached.

44. System according to claim 28, wherein the structural unit is a motor and the structural member is a chassis or a device housing.

45. System according to claim 44, wherein the oscillation device has two degrees of freedom in the plane perpendicular to the motor axis.

46. System according to claim 28, wherein the structural unit is a wheel hub or a vehicle axle and the structural member is a chassis.

47. System according to claim 46, comprising an oscillation device according to claim 24.

48. System according to claim 28, wherein the structural unit is a sound generator, such as a vibrating machine, or a musical instrument, in particular a piano or grand piano, and the structural member is a basis on which the structural unit rests.
